(19) United States
(12) Patent Application Publication
(10) Pub. No.: US 2024/0378252 A1
(43) Pub. Date: Nov. 14, 2024

(54) DETERMINING AND PROVIDING RECOMMENDED GENEALOGICAL CONTENT ITEMS USING A SELECTION-PREDICTION NEURAL NETWORK

(71) Applicant: Ancestry.com Operations Inc., Lehi, UT (US)

(72) Inventors: Xiaoxuan Zhang, San Francisco, CA (US); Debora Donato, Mill Valley, CA (US); Zachary Monroe White, Provo, UT (US); Karl Walter Judson, Cedar Hills, UT (US); Madhu Shivashankaraiah, Redmond, WA (US); Chen Li, New York, NY (US)

(21) Appl. No.: 18/660,046

(22) Filed: May 9, 2024

Related U.S. Application Data
(60) Provisional application No. 63/501,181, filed on May 10, 2023.

(51) Int. Cl. G06F 16/9535; G06F 16/9538

(52) U.S. Cl. CPC G06F 16/9535; G06F 16/9538

(57) ABSTRACT

The present disclosure is directed toward systems, methods, and non-transitory computer-readable media for generating and providing recommended genealogical content items using a selection-prediction neural network. For example, the disclosed systems utilize a transformer-based selection-prediction neural network to generate selection predictions for genealogical content items according to previous client device interactions as well as genealogical metrics, including content-based genealogical metrics, tree-level genealogical metrics, and/or account-level genealogical metrics. In some cases, the disclosed systems train a selection-prediction neural network by learning network parameters based on features extracted from content items, client device behavior, genealogy trees, and user accounts.

### CROSS-REFERENCE TO RELATED APPLICATIONS

The present application claims priority to, and the benefit of, U.S. Provisional Application No. 63/501,181, titled DETERMINING AND PROVIDING RECOMMENDED GENEALOGICAL CONTENT ITEMS USING A SELECTION PREDICTION NEURAL NETWORK, filed on May 10, 2023. The aforementioned application is hereby incorporated by reference in its entirety.

### BACKGROUND

Advancements in computing devices and networking technology have given rise to a variety of innovations in cloud-based genealogical data storage, sharing, and generation. For example, online historical content systems can provide access to genealogical content items across devices all over the world. Existing systems can also analyze genealogical data for specific user accounts and can identify additional genealogical content items relevant to the user accounts based on the analysis. For example, modern historical content systems can identify family members of a user account based on genealogy tree databases, and some existing systems can even identify relevant digitized newspaper articles, images, census records, obituaries, court documents, and other types of digitized historical documents (or other content items) relevant to the user account. Despite these advances, however, existing historical content systems continue to suffer from a number of disadvantages, particularly in terms of flexibility and accuracy.

As just suggested, certain existing historical content systems are inflexible. More particularly, when identifying relevant content items to surface to client devices, many existing systems apply purely heuristic algorithms in a one-size-fits-all approach. To elaborate, existing systems often apply a fixed set of rules to identify a content item to surface for a user account, irrespective of contextual data such as account behavior and/or kinship relationships among genealogical content items. Consequently, existing systems often generate generic content recommendations that are not adapted to user accounts. Further along these lines, some existing systems cannot adapt content recommendations for sampling across multiple content types, instead skewing recommendations toward a single type of content item (e.g., a content type for which a heuristic algorithm is designed and/or a content type that is most prevalent or most popular within a database), or following rigid and impersonal heuristic approaches, repeatedly surfaces content of a particular type or content, reducing user engagement

Due at least in part to their inflexible architectures, some existing historical content systems are inaccurate. More specifically, existing systems often inaccurately identify relevant content items to surface to a client device as a result of inflexible heuristic algorithms that are not adaptive to user account context (and/or context of genealogical content items themselves). Indeed, some existing systems identify irrelevant content items for a user account because the heuristic approaches of these systems cannot adapt to changes in account behavior and/or cannot account for kinship relationships among content items that are indicative of relevance.

### SUMMARY

This disclosure describes one or more embodiments of systems, methods, and non-transitory computer-readable storage media that provide benefits and/or solve one or more of the foregoing and other problems in the art. For instance, the disclosed systems generate and provide recommended genealogical content items using a selection-prediction neural network. For example, the disclosed systems utilize a transformer-based selection-prediction neural network to generate selection predictions for genealogical content items according to previous client device interactions as well as genealogical metrics, including content-based genealogical metrics, tree-level genealogical metrics, and/or account-level genealogical metrics. In some cases, the disclosed systems train a selection-prediction neural network by learning network parameters based on features extracted from content items, client device behavior, genealogy trees, and/or user accounts.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a genealogical-content prediction system operates in accordance with one or more embodiments.

FIG. 2 illustrates an example overview of generating a selection prediction for a content item and generating a content recommendation based on the selection prediction in accordance with one or more embodiments.

FIG. 3 illustrates an example high-level architecture diagram of a selection-prediction neural network in accordance with one or more embodiments.

FIG. 4 illustrates an example detailed architecture diagram for a selection-prediction neural network in accordance with one or more embodiments.

FIG. 5 illustrates an example architecture diagram for a kinship embedding block in accordance with one or more embodiments.

FIG. 6 illustrates an example architecture diagram for an embedding block of a selection-prediction neural network in accordance with one or more embodiments.

FIG. 7 illustrates an example architecture diagram for a transformer encoder block in accordance with one or more embodiments.

FIG. 8 illustrates an example modification for enforcing content diversity in a selection-prediction neural network in accordance with one or more embodiments.

FIGS. 9A-9B illustrate example tables including experimental results for the genealogical-content prediction system in accordance with one or more embodiments.

FIGS. 10A-10B illustrate example graphs depicting experimental results and/or analytical insights for the genealogical-content prediction system in accordance with one or more embodiments.

FIG. 11 illustrates an example graph reflecting content diversity in recommended content in accordance with one or more embodiments.

FIG. 12 illustrates a client device displaying an example graphical user interface for providing and presenting recommended content items in accordance with one or more embodiments.

FIGS. 13A-13C illustrate example graphical user interfaces for providing and displaying recommended content items in accordance with one or more embodiments.

FIG. 14 illustrates an example series of acts for generating selection predictions using a selection-prediction neural network in accordance with one or more embodiments.

FIG. 15 illustrates an example series of acts for training a selection-prediction neural network in accordance with one or more embodiments.

FIG. 16 illustrates a block diagram of an example computing device for implementing one or more embodiments of the present disclosure.

FIG. 17 illustrates an example environment of a networking system having the genealogical-content prediction system in accordance with one or more embodiments.

FIG. 18 illustrates an example series of acts for providing content items based on feed rankings in accordance with one or more embodiments.

### DETAILED DESCRIPTION

This disclosure describes one or more embodiments of a genealogical-content prediction system that can determine and provide relevant genealogical content items for display on client devices. In many scenarios, user accounts access genealogical content items (e.g., digitized newspaper articles, records, and other types of digitized historical documents) to link family members stored (as nodes) within genealogical trees within one or more genealogical tree databases and/or to add contextual information to existing nodes within genealogical trees. As part of this process, the genealogical-content prediction system can generate and provide recommendations for relevant genealogical content items that inform the linking of additional nodes and/or adding of contextual data to existing nodes.

To provide relevant genealogical content items, the genealogical-content prediction system can determine genealogical metrics associated with content items stored in one or more genealogical databases. In addition, the genealogical-content prediction system can utilize a selection-prediction neural network to generate selection predictions for respective genealogical content items from or based on the genealogical metrics. Such genealogical metrics can include content-level genealogical metrics, tree-level genealogical metrics, and account-level genealogical metrics. In some cases, the genealogical-content prediction system utilizes the selection-prediction neural network to process a set of genealogical metrics associated with a content item to generate a selection prediction for the content item.

As part of determining content-level genealogical metrics, the genealogical-content prediction system can determine kinship relationships between nodes of a genealogy tree. For instance, the genealogical-content prediction system can utilize specialized layers of a selection-prediction neural network to encode or extract kinship embeddings from tree nodes (e.g., from data for individuals represented by tree nodes). In some cases, the genealogical-content prediction system can determine or extrapolate kinship for and/or between content items based on the kinship embeddings from nodes associated with the content items. The genealogical-content prediction system can thereby encode or define the relatedness between user accounts and/or between a user account and content items. As an additional part of utilizing the selection-prediction neural network, the genealogical-content prediction system can enforce or utilize a content-diversity metric to facilitate sampling from different types of content items when selecting recommended genealogical content items. As yet a further part of utilizing the selection-prediction neural network, the genealogical-content prediction system can account for user account behavior using one or more specialized layers of the selection-prediction neural network.

Based on generating selection predictions for a number of genealogical content items according to genealogical metrics (including content-, tree-, and account-level genealogical metrics) and/or a content-diversity metric, the genealogical-content prediction system can select a set of content items to provide to a client device. More specifically, the genealogical-content prediction system can compare selection predictions and can select a number of highest-scoring content items (or a number of content items with selection predictions that satisfy a selection prediction threshold). Indeed, the genealogical-content prediction system can provide one or more genealogical content items for display within a genealogical user interface on a client device.

As suggested above, the genealogical-content prediction system can provide several improvements or advantages over existing historical content systems. For example, the genealogical-content prediction system utilizes a first-of-its-kind neural network (e.g., the selection-prediction neural network described herein) to generate selection predictions for genealogical content items for surfacing content items relevant to user accounts. More specifically, the genealogical-content prediction system utilizes a selection-prediction neural network with a unique architecture to process unique genealogical data to generate selection predictions for genealogical content items. As part of its unique architecture (which is described below), the selection-prediction neural network includes specialized layers for encoding kinship embeddings and for enforcing content-diversity metrics to sample content items across a variety of content types.

Due at least in part to utilizing a selection-prediction neural network with its unique architecture, the genealogical-content prediction system can provide improved flexibility over prior systems. While many prior systems utilize heuristic algorithms to apply fixed rule sets to identify relevant content items in a uniform fashion across all user accounts, the genealogical-content prediction system can flexibly adapt recommended genealogical content items on a per-account basis. For example, the genealogical-content prediction system can utilize a selection-prediction neural network that accounts for account-specific behavior signals and that extracts kinship embeddings on an account-specific basis as well. Accordingly, the genealogical-content prediction system can adaptively determine genealogical content items to recommend to a user account that are specifically tailored to contextual data surrounding the user account. Furthermore, the genealogical-content prediction system also utilizes a content-diversity metric as part of applying the selection-prediction neural network, thereby facilitating a more even sampling of different content types than prior systems that do not account for content diversity.

In addition, the genealogical-content prediction system can also improve accuracy over prior systems. To elaborate, while some prior systems inaccurately identify relevant content items to recommend due to their rigid heuristic algorithms, the genealogical-content prediction system can accurately identify and select genealogical content items to provide to client devices. Indeed, the genealogical-content prediction system can utilize a selection-prediction neural network to generate accurate, account-specific selection predictions that indicate the probability that a user account will select (or otherwise interact with) respective content items. Specifically, the selection-prediction neural network accounts for user account behavior as well as genealogical metrics not available in prior systems (e.g., kinship and content diversity) to more accurately determine recommended content items.

As yet a further advantage, relating specifically to encoding or extracting kinship embeddings, the genealogical-content prediction system can utilize a specialized encoding technique to capture kinship without overburdening computer processors or generating data too large for computer storage. To elaborate, the genealogical-content prediction system can utilize a character-level embedder as part of a selection-prediction neural network to generate kinship embeddings on a character level (e.g., one character at a time). Accordingly, the genealogical-content prediction system greatly reduces the embedding size of a kinship embedding from a theoretical size of 12²⁵ (an enormous embedding size that is not feasible for storage or network training) to a fixed constant of 329. Indeed, kinship embeddings are encoded from strings of up to 12 unique characters having a maximum length of 25 characters. Thus, generating embeddings directly from such large strings is not feasible, and the genealogical-content prediction system instead utilizes a character-level embedder to generate character-level kinship embeddings and to combine the character-level kinship embeddings into an overall kinship embedding. The genealogical-content prediction system thus saves computer resources such as processing power, memory, and storage while also facilitating much faster network training than would otherwise be attainable.

As another advantage, certain embodiments of the genealogical-content prediction system improve navigational efficiency over prior systems, especially for mobile applications. To elaborate, many prior systems utilize mobile device applications to surface content items within interfaces having limited screen space (due to physical device size). Due to their aforementioned inaccuracies, however, many such systems surface too many (and/or irrelevant) content items in the limited mobile interface space, requiring excessive scrolling and navigating to eventually locate relevant content items that may be many (e.g., tens or hundreds) of results down the list (thus requiring many navigational scrolling inputs). By contrast, the genealogical-content prediction system can much more accurately surface relevant content items, filtering out erroneous and/or duplicative items and providing those much more likely to selected at the top of the results. Compared to prior systems, the genealogical-content prediction system thus greatly reduces the number of navigational inputs required to located desired data and/or functionality in relation to genealogical content items.

While embodiments of the genealogical-content prediction system primarily relate to the context of genealogical data and genealogical content items, the genealogical-content prediction system can perform the processes described herein on other data as well. For example, the genealogical-content prediction system can generate or determine content items to recommend to a user account using a selection-prediction neural network. Indeed, based on factors such as client device interaction, account-level metrics, and relational (e.g., tree-level) metrics, the genealogical-content prediction system can determine content items to surface to client devices. Accordingly, this disclosure is not limited to genealogical data but is extendable to content items in other domains.

As illustrated by the foregoing discussion, the present disclosure utilizes a variety of terms to describe features and benefits of the genealogical-content prediction system. Additional detail is hereafter provided regarding the meaning of these terms as used in this disclosure. As used herein, the term “genealogical content item” (or simply “content item”) refers to a digital object or a digital file that includes information (e.g., genealogical information) interpretable by a computing device (e.g., a client device) to present information to a user. A genealogical content item can include a file such as a digital text file, a digital image file, a digital audio file, a webpage, a website, a digital video file, a web file, a link, a digital document file, or some other type of file or digital object. A genealogical content item can have a particular file type or file format, which may differ for different types of digital content items (e.g., digital documents. digital images, digital videos, or digital audio files). In some cases, a genealogical content item can refer to a content item that includes or depicts historical or genealogical information, such as a record hint, a story, a digital image, a new person hint, a member tree hint, a DNA match, a digitized birth, marriage, or death record, a digitized newspaper article, a digitized photograph of a relative, a digitized census record, a digitized obituary, a digitized court document, a digitized DNA analysis, or a digitized family tree.

In addition, as used herein, the term “neural network” refers to a machine learning model that can be trained and/or tuned based on inputs to determine classifications, scores, or approximate unknown functions. For example, a neural network includes a model of interconnected artificial neurons (e.g., organized in layers) that communicate and learn to approximate complex functions and generate outputs (e.g., selection predictions) based on a plurality of inputs provided to the neural network. In some cases, a neural network refers to an algorithm (or set of algorithms) that implements deep learning techniques to model high-level abstractions in data. A neural network can include various layers such as an input layer, one or more hidden layers, and an output layer that each perform tasks for processing data. For example, a neural network can include a deep neural network, a convolutional neural network, a recurrent neural network (e.g., an LSTM), a graph neural network, a transformer neural network, or a generative neural network (e.g., a generative adversarial neural network). Upon training, as described below, such a neural network may become a “selection-prediction neural network” that generates selection predictions for genealogical content items based on genealogical metrics and/or user account behavior.

Relatedly, as used herein, the term “selection prediction” refers to a generated prediction, such as a probability or a likelihood, that a content item will be selected (or otherwise interacted with) via a graphical user interface. For example, a selection prediction includes a probability that is specific to a user account and that is also specific to a genealogical content item, indicating the chances that the user account will select or otherwise interact with the content item. In some cases, a selection prediction is a reflection of a user intent for a user account, represented by a normalized prediction value (e.g., a number from 0 to 1), where higher numbers indicate higher probabilities/likelihoods of selection than lower numbers.

As mentioned, the genealogical-content prediction system can generate a selection prediction based on genealogical metrics and/or user account behavior. As used herein, the term “genealogical metric” refers to a (data-driven) metric, parameter, or factor that defines or indicates genealogical information regarding a content item, a node of a genealogy tree, or a user account. For example, a “content-level genealogical metric” refers to a genealogical metric that is derived from, extracted from, or specific to a genealogical content item. In addition, a “tree-level genealogical metric” refers to a genealogical metric that is derived from, extracted from, or specific to a genealogy tree. Along these lines, an “account-level genealogical metric” refers to a genealogical metric that is derived from, extracted from, or specific to a user account.

In some embodiments, the genealogical-content prediction system extracts a content-level genealogical metric in the form of a kinship embedding. As used herein, the term “kinship embedding” refers to a network embedding or encoding that defines or represents a relatedness or a consanguinity between nodes, content items, or entities. For example, a kinship embedding refers to a vector representation of a kinship between a content item (or its corresponding node) and another node, between two content items associated with respective nodes, and/or between two nodes.

As mentioned above, the genealogical-content prediction system can utilize a content-diversity metric in implementing a selection-prediction neural network to generate selection predictions. As used herein, the term “content-diversity metric” refers to a metric, a parameter, or a value that influences, impacts, or enforces diversity among genealogical content items selected for display on a client device, or is configured and/or utilized so to do. For example, a content-diversity metric refers to a number of unique content types or content categories in a set of genealogical content items (e.g., a set of provided content items and/or selected content items). In some cases, a content-diversity metric can include a number of unique categories in citations and hint creation, where a citation refers to a hint acceptance or a search success.

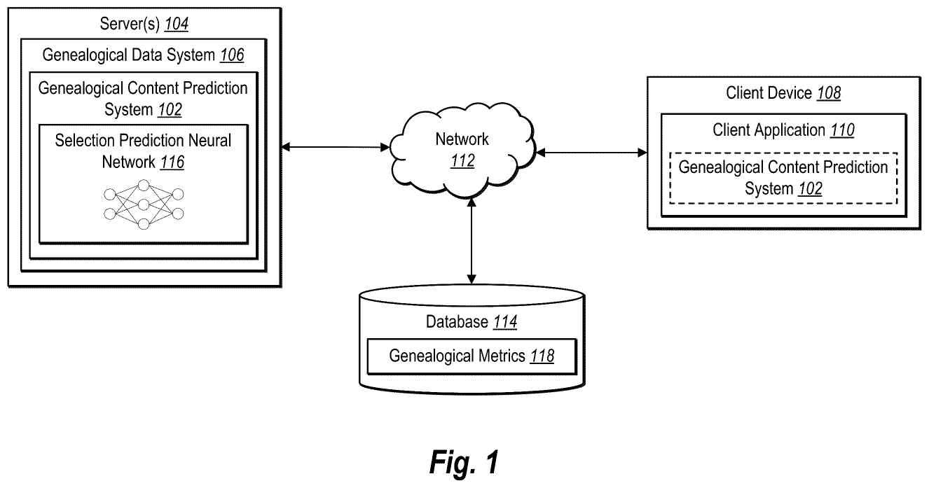

Additional detail regarding the genealogical-content prediction system will now be provided with reference to the figures. For example, FIG. 1 illustrates a schematic diagram of an example system environment for implementing a genealogical-content prediction system 102 in accordance with one or more implementations. An overview of the genealogical-content prediction system 102 is described in relation to FIG. 1. Thereafter, a more detailed description of the components and processes of the genealogical-content prediction system 102 is provided in relation to the subsequent figures.

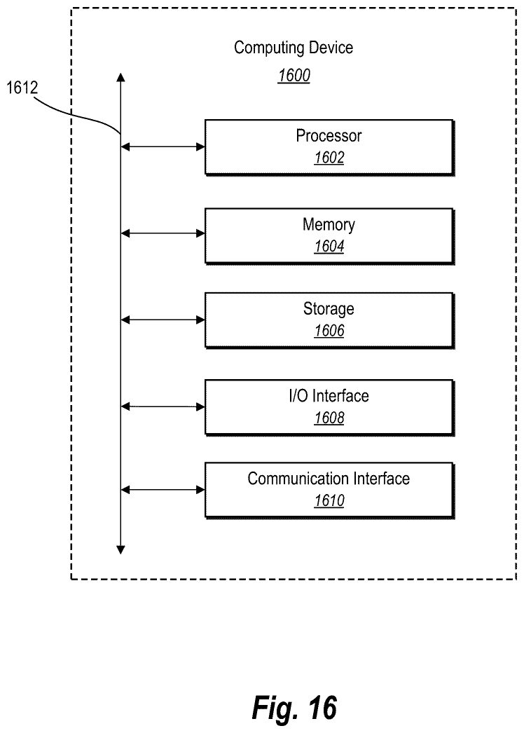

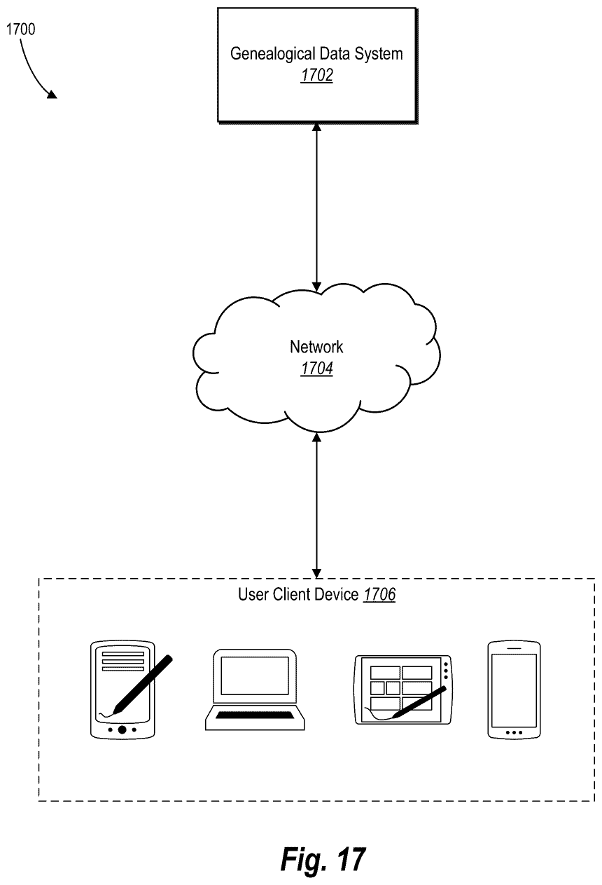

As shown, the environment includes server(s) 104, a client device 108, a database 114, and a network 112. Each of the components of the environment can communicate via the network 112, and the network 112 may be any suitable network over which computing devices can communicate. Example networks are discussed in more detail below in relation to FIGS. 16-17.

As mentioned above, the example environment includes a client device 108. The client device 108 can be one of a variety of computing devices, including a smartphone, a tablet, a smart television, a desktop computer, a laptop computer, a virtual reality device, an augmented reality device, or another computing device as described in relation to FIGS. 16-17. The client device 108 can communicate with the server(s) 104 and/or the database 114 via the network 112. For example, the client device 108 can receive user input from respective users interacting with the client device 108 (e.g., via a client application 110) to, for instance, access, generate, modify, or share a genealogical content item and/or to interact with a genealogy tree or a content item via a graphical user interface of a genealogical data system 106. In addition, the genealogical-content prediction system 102 on the server(s) 104 can receive information relating to various interactions with content items and/or user interface elements based on the input received by the client device 108.

As shown, the client device 108 can include a client application 110. In particular, the client application 110 may be a web application, a native application installed on the client device 108 (e.g., a mobile application, a desktop application, etc.), or a cloud-based application where all or part of the functionality is performed by the server(s) 104. Based on instructions from the client application 110, the client device 108 can present or display information, including a user interface such as a genealogy tree interface, a discover interface for additional genealogical content, or some other graphical user interface, as described herein.

As illustrated in FIG. 1, the example environment also includes the server(s) 104. The server(s) 104 may generate, track, store, process, receive, and transmit electronic data, such as genealogical content items and/or interactions with content items. For example, the server(s) 104 may receive data from the client device 108 in the form of an indication of a selection to view a particular graphical user interface or to select a particular genealogical content item. In addition, the server(s) 104 can transmit data to the client device 108 in the form of a genealogical content recommendation based within a graphical user interface. Indeed, the server(s) 104 can communicate with the client device 108 to send and/or receive data via the network 112. In some implementations, the server(s) 104 comprise(s) a distributed server where the server(s) 104 include(s) a number of server devices distributed across the network 112 and located in different physical locations. The server(s) 104 can comprise one or more content servers, application servers, communication servers, web-hosting servers, machine learning servers, and other types of servers.

As shown in FIG. 1, the server(s) 104 can also include a genealogical-content prediction system 102 as part of a genealogical data system 106. The genealogical data system 106 can communicate with the client device 108 to perform various functions associated with the client application 110 such as managing user accounts, managing genealogical data, managing genealogy trees, managing genealogical content items, and facilitating user interaction with, and sharing of, the genealogy trees and/or genealogical content items. Indeed, the genealogical data system 106 can include a network-based cloud storage system to manage, store, and maintain genealogical content items and genealogy trees related to data user accounts. For instance, the genealogical data system 106 can utilize genealogical data across various content items and user accounts to generate and maintain a universal genealogy tree that reflects the relatedness or consanguinity between nodes corresponding to all user accounts and other individuals indicated by stored genealogical content items. In some embodiments, the genealogical-content prediction system 102 and/or the genealogical data system 106 utilize the database 114 to store and access information such as genealogical metrics 118 (e.g., account-level genealogical metrics, tree-level genealogical metrics, and/or content-level genealogical metrics), genealogical content items, genealogy trees, user account data, and other information.

In addition, the genealogical-content prediction system 102 includes a selection-prediction neural network 116. In particular, the genealogical-content prediction system 102 trains and utilizes the selection-prediction neural network 116 to generate selection predictions for genealogical content items as a basis for selecting content items to recommend to user accounts. For instance, the genealogical-content prediction system 102 utilizes the selection-prediction neural network 116 to process genealogical metrics for a content item and to generate a selection prediction for the content item from the genealogical metrics.

Although FIG. 1 depicts the genealogical-content prediction system 102 located on the server(s) 104, in some implementations, the genealogical-content prediction system 102 may be implemented by (e.g., located entirely or in part on) one or more other components of the environment. For example, the genealogical-content prediction system 102 may be implemented in whole or in part by the client device 108. For example, the client device 108 and/or a third-party system can download all or part of the genealogical-content prediction system 102 for implementation independent of, or together with, the server(s) 104. Accordingly, the client device 108 can perform all or part of the implementation and/or training of the selection-prediction neural network 116 described herein.

In some implementations, though not illustrated in FIG. 1, the environment may have a different arrangement of components and/or may have a different number or set of components altogether. For example, the client device 108 may communicate directly with the genealogical-content prediction system 102, bypassing the network 112. As another example, the environment may include multiple client devices 108, each associated with a different user account. In addition, the environment can include the database 114 located external to the server(s) 104 (e.g., in communication via the network 112) or located on the server(s) 104 and/or on the client device 108.

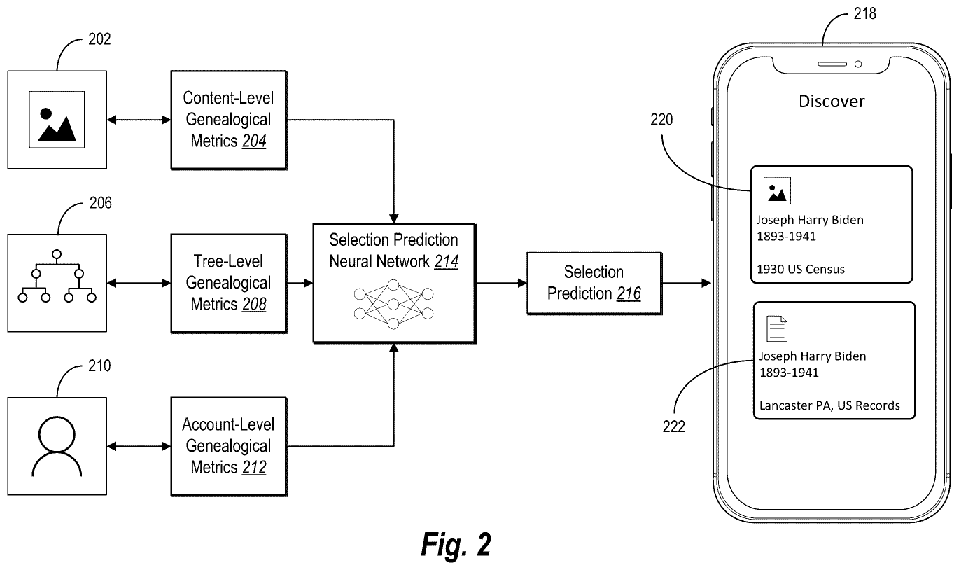

As mentioned above, the genealogical-content prediction system 102 can identify and select genealogical content items to provide to a user account based on selection predictions of the content items. In particular, the genealogical-content prediction system 102 can provide recommended content items in the form of record hints, stories, digital images, birth, marriage, and death records, new person hints, member tree hints, and/or DNA matches. FIG. 2 illustrates an example overview of generating a selection prediction for a content item and generating a content recommendation based on the selection prediction in accordance with one or more embodiments. The description of FIG. 2 provides an overview of this process, and additional detail regarding the various acts and methods described in FIG. 2 is provided thereafter with reference to subsequent figures.

As illustrated in FIG. 2, the genealogical-content prediction system 102 accesses or analyzes a genealogical content item 202 (e.g., a digital image as shown). More specifically, the genealogical-content prediction system 102 analyzes the genealogical content item 202 to generate, determine, or extract content-level genealogical metrics 204. For instance, the genealogical-content prediction system 102 extracts content-level genealogical metrics 204 that include: i) a content type, ii) a kinship, iii) a database category, iv) a relevance score, and v) a role identifier. Indeed, the genealogical-content prediction system 102 generates or determines the content-level genealogical metrics 204 for the genealogical content item 202 by accessing stored data in a database and/or by utilizing one or more models.

Regarding the content-level genealogical metrics 204, in some embodiments, the genealogical-content prediction system 102 determines a content type for the genealogical content item 202. Specifically, the genealogical-content prediction system 102 determines the content type by accessing data that indicates that the genealogical content item 202 is one of a record hint, a story, a digital image, a new person hint, a member tree hint, a DNA match, a digitized birth, marriage, or death record, a digitized newspaper article, a digitized photograph of a relative, a digitized census record, a digitized obituary, a digitized court document, a digitized DNA analysis, or a digitized family tree.

In addition, the genealogical-content prediction system 102 can determine a kinship for the genealogical content item 202. For example, the genealogical-content prediction system 102 determines a relationship between the genealogical content item 202 and a particular user account (e.g., the user account associated with the client device 218). In some cases, the genealogical-content prediction system 102 determines the kinship by identifying a node corresponding to the genealogical content item 202 within a genealogy tree and by further identifying a node corresponding to the user account within the genealogy tree. Further, the genealogical-content prediction system 102 can compare the node for the genealogical content item 202 and the node for the user account to determine the kinship of the genealogical content item 202 in relation to the user account. For instance, the genealogical-content prediction system 102 can determine kinships for previously unlinked (e.g., newly added or newly discovered) content items by resolving entities mentioned in the content items to nodes (or user accounts) of corresponding trees. The genealogical-content prediction system 102 can also (or alternatively) determine the kinship of the genealogical content item 202 in relation to any other node of a genealogy tree.

As a further example of the content-level genealogical metrics 204, the genealogical-content prediction system 102 can extract or determine a database category for the genealogical content item 202. More specifically, the genealogical-content prediction system 102 can determine a category where the genealogical content item 202 is stored within a database (e.g., the database 114). Example database categories include census records, directories, court documents, military records, immigration records, and birth-marriage-death records.

Additionally, the genealogical-content prediction system 102 can determine a relevance score for the genealogical content item 202. In some embodiments, the genealogical-content prediction system 102 determines a relevance score by utilizing a relevance score generation model. For instance, the genealogical-content prediction system 102 generates a relevance score by processing the genealogical content item 202 to extract features from the genealogical content item 202 and to compare those extracted features with features of a user account (e.g., by determining distances or cosine similarities between feature embeddings in a feature space).

To elaborate, the relevance score generation model generates relevance scores for modifying a cluster database. The relevance score generation model includes a feature extractor and a score generator that generates a relevance score based on features extracted from the feature extractor. Specifically, the score generator combines feature vectors into a metric function to compare the feature vectors and determine a measure of relevance between them. In some embodiments, the score generator determines a relevance score according to the following equation:

$$t = {\sum }_{i = 1}^{n} {w}_{i} * s ( {f}_{i} )$$

where n represents the number of features fᵢ and wᵢ represents a feature weight for the i^{th} feature. Indeed, the score generator of the relevance score generation model determines a relevance score based on a weighted sum of metric function s (fᵢ) weighted by wᵢ.

In some instances, based on a relevance score, the genealogical-content prediction system 102 makes a node connection between two nodes corresponding to two persons in different trees and checks whether that node resolves to a current entity cluster or whether it should resolve to its own cluster. The term “cluster” may refer to a grouping of tree persons, each from different trees and each determined to correspond to the same real-life individual. Although clusters are designed to group only tree persons that correspond to the same real-life individual, this is not always possible, and often clusters are either overinclusive or underinclusive based on the similarity threshold that is employed. The genealogical-content prediction system 102 can thus generate a relevance score for the genealogical content item 202 in relation to a user account based on the distance/similarity of the feature embedding from the account embedding in the feature space.

Further, the genealogical-content prediction system 102 can determine a role identifier for the genealogical content item 202. More particularly, the genealogical-content prediction system 102 can determine whether the genealogical content item 202 corresponds to a father or a mother of a user account. To elaborate, the genealogical-content prediction system 102 can determine (or receive an indication from the client device 218) that the genealogical content item 202 describes, depicts, or otherwise corresponds to a father (e.g., a male parent node) or a mother (e.g., a female parent node) in relation to a node for a user account within a genealogy tree. In some embodiments, the genealogical-content prediction system 102 can determine role identifiers for other roles, such as siblings, spouses, children, grandparents, or other relative designators.

As further illustrated in FIG. 2, the genealogical-content prediction system 102 generates, determines, or extracts tree-level genealogical metrics 208 from a genealogy tree 206. To elaborate, the genealogical-content prediction system 102 analyzes the genealogy tree 206 associated with a particular user account (e.g., the user account associated with the client device 218) to determine the tree-level genealogical metrics 208. In some cases, the tree-level genealogical metrics 208 include a node count, an image count, a story count, and/or an attached records count. Indeed, the genealogical-content prediction system 102 can determine a number of nodes within the genealogy tree 206, a number of images within (or linked to nodes within) the genealogy tree 206, a number of stories within (or linked to nodes within) the genealogy tree 206, and/or a number of historical records within (or linked to nodes within) the genealogy tree 206.

In addition, the genealogical-content prediction system 102 can generate, determine, or extract account-level genealogical metrics 212 from a user account 210 (e.g., a user account associated with the client device 218). In particular, the genealogical-content prediction system 102 can access user account data stored within a database (e.g., the database 114) to determine the account-level genealogical metrics 212. In some cases, the account-level genealogical metrics 212 include a set of user account skill scores and a hintability group associated with the user account 210.

As also shown in FIG. 2, the genealogical-content prediction system 102 generates a selection prediction 216 from the content-level genealogical metrics 204, the tree-level genealogical metrics 208, and the account-level genealogical metrics 212. Specifically, the genealogical-content prediction system 102 utilizes a selection-prediction neural network 214 to process the content-level genealogical metrics 204, the tree-level genealogical metrics 208, and the account-level genealogical metrics 212 to generate the selection prediction 216. As described in further detail below, the selection-prediction neural network 214 has a unique transformer-based architecture for processing genealogical metrics to generate selection predictions.

Additionally, as illustrated in FIG. 2, the genealogical-content prediction system 102 can generate recommended content items, such as the content recommendation 220 and the content recommendation 222, for a user account. Specifically, the genealogical-content prediction system 102 can generate a number of selection predictions for different genealogical content items and can compare the selection predictions to select a threshold number of top-scoring genealogical content items to provide to the client device 218. In some embodiments, the genealogical-content prediction system 102 generates and provides the content recommendation 220 for a top-scoring genealogical content item and further generates and provides the content recommendation 222 for a second-highest scoring genealogical content item.

As shown, the content recommendation 220 and the content recommendation 222 are of different content types. Indeed, the content recommendation 220 is a census record, whereas the content recommendation 222 is a birth, marriage, or death record from Pennsylvania. To ensure or encourage generating content recommendations that are diverse across different content types, the genealogical-content prediction system 102 can further utilize a content-diversity metric. Indeed, as part of utilizing the selection-prediction neural network 214, the genealogical-content prediction system 102 can satisfy a content-diversity metric by adding and processing additional genealogical metrics. Specifically, in some cases, the genealogical-content prediction system 102 processes additional tree-level genealogical metrics that cause the selection-prediction neural network 214 to integrate content diversity as part of generating selection predictions. Additional detail regarding content diversity is provided below.

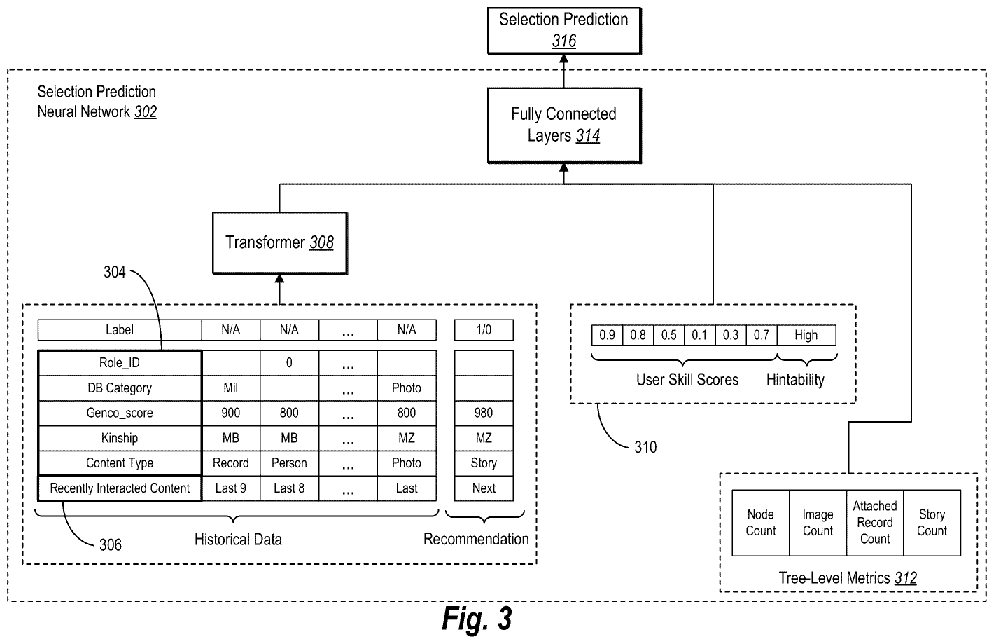

As indicated above, the genealogical-content prediction system 102 utilizes a selection-prediction neural network to generate selection predictions. In particular, the genealogical-content prediction system 102 utilizes a selection-prediction neural network 214 having an architecture to process content-level genealogical metrics, account-level genealogical metrics, and tree-level genealogical metrics. FIG. 3 illustrates an example high-level architecture of a selection-prediction neural network in accordance with one or more embodiments.

As shown in FIG. 3, the genealogical-content prediction system 102 utilizes a selection-prediction neural network 302 to generate a selection prediction 316. For example, the selection-prediction neural network 302 generates the selection prediction 316 as a probability or likelihood of receiving a client device interaction with a genealogical content item. In some cases, the selection prediction 316 is a probability of a particular type of client device interaction, such as an acceptance interaction (e.g., a selection of an acceptance option included as part of a recommended genealogical content item), a maybe interaction (e.g., a selection of a maybe option included as part of a recommended genealogical content item), a pending interaction (e.g., waiting for an interaction, unviewed, and/or viewed and waiting for a selection), a rejection interaction (e.g., a selection of a rejection option included as part of a recommended genealogical content item), or a dismissal interaction (e.g., a selection to close or dismiss a window of a recommended genealogical content item).

As illustrated in FIG. 3, the selection-prediction neural network 302 includes a transformer 308 for learning sequence patterns of user interactions with content items, while also incorporating content-level genealogical metrics 304. To elaborate, the selection-prediction neural network 302 includes a transformer 308 that processes content-level genealogical metrics 304. As shown, the content-level genealogical metrics 304 include metrics such as: i) a content type, ii) a kinship, iii) a database category, iv) a relevance score, and v) a role identifier and 6) recently interacted content (i.e., the account behavior 306). In some embodiments, the content-level genealogical metrics 304 include account behavior 306, while in other embodiments the account behavior 306 is separate from the content-level genealogical metrics 304. Indeed, the selection-prediction neural network 302 includes embedding layers for embedding the content-level genealogical metrics 304 and account behavior 306. The account behavior 306 can represent interactions with up to a threshold number (e.g., nine) of previously interacted content items (e.g., previously viewed person hints).

As shown, the selection-prediction neural network 302 distinguishes between historical data for the content-level genealogical metrics 304 and a recommendation generated based on the historical data. In one or more embodiments, the transformer 308 learns patterns of client device interactions represented by the account behavior 306. Indeed, the transformer 308 processes the historical data for each of a previous number of selected (or otherwise interacted) genealogical content items, where each previously interacted content item has its own Role ID, database category, relevance score, kinship, and content type. Based on learning interaction patterns from the content-level genealogical metrics 304, the transformer 308 thus generates and/or processes a recommendation where each of the content-level metrics of the recommendation are based on the corresponding historical data fields.

As just mentioned, the genealogical-content prediction system 102 determines a role identifier for a genealogical content item. A role identifier indicates a parental relationship between a user account and a genealogical content item (e.g., a new person hint). For instance, the genealogical-content prediction system 102 determines that a content item describes or includes data for a mother or a father of the user account. Indeed, the genealogical-content prediction system 102 accesses and/or analyzes a genealogical tree for the user account to determine a father node and/or a mother node. The genealogical-content prediction system 102 further compares stored data for the father node and/or the mother node to compare with a genealogical content item. In some cases, the genealogical-content prediction system 102 determines a role identifier as a probability or a scaled score indicating how likely it is that a content item corresponds to either parent of a user account. In certain embodiments, the genealogical-content prediction system 102 generates a role identifier to indicate which parent (e.g., mother or father) corresponds to a content item, and how likely such correspondence is.

As another of the content-level genealogical metrics 304, the genealogical-content prediction system 102 determines a database category (or a database category) for a genealogical content item. In particular, the genealogical-content prediction system 102 determines a database category for the database that stores or houses the genealogical content item. Indeed, the genealogical-content prediction system 102 manages and maintains a plurality of databases for different categories or types of genealogical content items. The genealogical-content prediction system 102 can thus determine the identification of the source database for a genealogical content item, such as a census records database, a directories database, a hints database, a court documents database, a military records database, an immigration records database, and/or a birth-marriage-death records database.

As yet another of the content-level genealogical metrics 304, the genealogical-content prediction system 102 can determine a relevance score. More specifically, the genealogical-content prediction system 102 determines a relevance score as a measure of relevance between a user account and a genealogical content item. In some cases, the genealogical-content prediction system 102 utilizes a relevance score generation model to generate a relevance score based on extracting and comparing content item features and user account features. The relevance score can thus indicate a measure or degree of how relevant a content item is to a user account based on data within the content item and data stored for the user account (and/or for relatives of the user account), including name data, date and location data for various life events (e.g., birth, marriage, death, birth of a child, immigration, military enlistment, purchase of a house, etc.).

Further, the genealogical-content prediction system 102 can determine content-level genealogical metrics 304 by determining a kinship. To elaborate, the genealogical-content prediction system 102 determines a kinship in the form of a relationship between a genealogical content item and a user account. For instance, the genealogical-content prediction system 102 identifies a node corresponding to the user account within a genealogy tree and compares stored data for the node with data of the genealogical content item. In some cases, the genealogical-content prediction system 102 identifies a node associated with the content item and determines the kinship by determining a relatedness or a closeness (e.g., a number of degrees of separation) within the genealogy tree between the content item node and the user account node.

Further still, the genealogical-content prediction system 102 can determine content-level genealogical metrics 304 by determining a content type. More particularly, the genealogical-content prediction system 102 determines a content type for a genealogical content item. For example, the genealogical-content prediction system 102 determines a category or type associated with the content item as labeled or stored in a database. Possible content types include, but are not necessarily limited to a record hint, a story, a digital image, a new person hint, a member tree hint, a DNA match, a digitized birth, marriage, or death record, a digitized newspaper article, a digitized photograph of a relative, a digitized census record, a digitized obituary, a digitized court document, a digitized DNA analysis, or a digitized family tree.

As further illustrated in FIG. 3, the selection-prediction neural network 302 includes an embedding block (e.g., an embedding layer) for account-level genealogical metrics 310. For example, the selection-prediction neural network 302 processes account-level genealogical metrics 310 including user skill scores and hintability. In some cases, a user skill score indicates a score or a rating reflecting or measure a proficiency or skill level associated with a user account. Indeed, the genealogical-content prediction system 102 can determine, track, and update user skill scores based on client device interactions with various tools within the genealogical data system 106 over time, such as searching tools, archiving tools, and indexing tools. Some tools are more sophisticated than others and, therefore, accurate/correct use of such tools results in higher user skill scores (e.g., normalized scores on a scale from 0 to 1), while incorrect use and/or use of only simpler tools results in lower user skill scores.

In addition, hintability indicates a hintability group or class associated with a user account, where the hintability groups include low, medium, and high hintability (or others). Depending on how much and/or what types of data are stored for a user account, the genealogical-content prediction system 102 determines a hintability that indicates how suitable the user account is for generating recommended content items (e.g., new person hints). A user account that relates to many different stored records which the user account has not yet seen or viewed has a higher hintability than a user account associated with view stored records and/or that has already viewed (or otherwise interacted with) most of the stored records. The selection-prediction neural network 302 thus encodes or extracts embeddings from the account-level genealogical metrics 310 to include as part of generating the selection prediction 316.

As also illustrated in FIG. 3, the selection-prediction neural network 302 includes an embedding block (e.g., an embedding layer) for tree-level genealogical metrics 312 as well. For example, the selection-prediction neural network 302 processes tree-level genealogical metrics 312 including node count, image count, attached record count, and story count. In some cases, node count indicates a number of nodes within a genealogy tree associated with a user account, which may include or exclude nodes combined or resolved together based on whether the nodes represent the same tree person (e.g., where a node of the user account is located). In addition, image count represents a number of digital images stored for a user account, including images of people, places, articles, or other records. Attached record count indicates a number of stored genealogical content items attached or associated with a user account (or an account node) within a genealogical database or a genealogy tree. Further, story count indicates a number of stories (e.g., a particular type of genealogical content item) associated with a user account (or an account node) within a genealogical database or a genealogy tree. The selection-prediction neural network 302 thus extracts or encodes embeddings from the tree-level genealogical metrics 312 to include as part of generating the selection prediction 316.

Further, the selection-prediction neural network 302 includes fully connected layers 314 for generating a selection prediction 316. Indeed, the fully connected layers 314 process and combined features extracted from the tree-level genealogical metrics 312, the account-level genealogical metrics 310, and the content-level genealogical metrics 304 (including the account behavior 306) to generate the selection prediction 316. In one or more embodiments, the selection-prediction neural network 302 includes one or more final layers (e.g., output layers) that are activated for downstream connections with other models or computer systems. Thus, the selection-prediction neural network 302 can plug into other workflows or systems that process and utilize the selection prediction 316 (and/or other extracted data of the selection-prediction neural network 302).

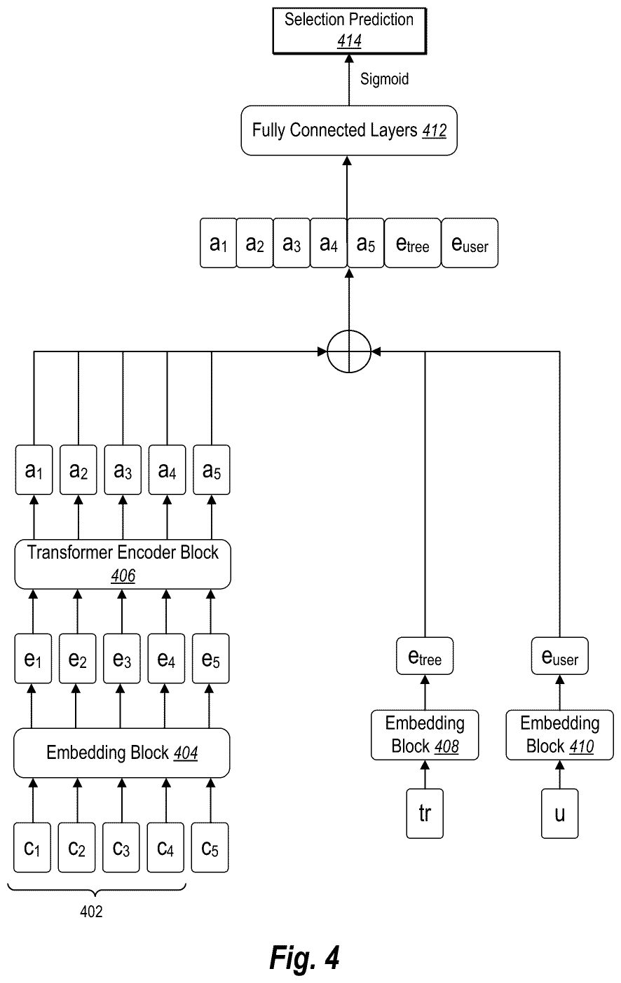

As mentioned above, in certain described embodiments, the genealogical-content prediction system 102 utilizes a selection-prediction neural network to generate selection predictions. In particular, the selection-prediction neural network can have a particular unique architecture for extracting and processing tree-level genealogical metrics, account-level genealogical metrics, and content-level genealogical metrics. FIG. 4 illustrates an example detailed architecture diagram for a selection-prediction neural network in accordance with one or more embodiments.

As illustrated in FIG. 4, the selection-prediction neural network includes an embedding block 404. In particular, the embedding block 404 processes content-level genealogical metrics for a set of content items, including previously viewed (or previously selected or otherwise previously interacted with) content items and a recommended next content item. As shown, c₁-c₄ represent the content items where content items c₁-c₄ form a selected set 402 and represent content items previously selected (or otherwise interacted with) by a user account, and where c₅ represents a candidate content item to be reviewed or analyzed next in the sequence (e.g., as a recommendation).

As shown, the embedding block 404 extracts or encodes content embeddings e₁-e₅ (e.g., content-level features) from the content items c₁-c₅ (or from content-level genealogical metrics of the content items c₁-c₅). Indeed, the embedding block 404 encodes the content embeddings in a feature space. In some embodiments, the embedding block 404 processes more than four previously interacted content items, up to a threshold number (e.g., nine), along with an additional recommended next content item. As an example, the content embedding e₄ may represent: i) a particular type of content item (e.g., a story hint), ii) with a particular relevance score (e.g., 900), and iii) for an individual's grandmother.

As further illustrated in FIG. 4, the selection-prediction neural network includes a transformer encoder block 406. The transformer encoder block 406 processes the content embeddings e₁-e₅ from the embedding block 404 to generate attention-based embeddings a₁-a₅. To elaborate, the transformer encoder block 406 generates the attention-based embeddings a₁-a₅ to capture entity features (e.g., content item features from the content embeddings e₁-e₅) as well as relationship features based on a cluster or distances among embeddings in the feature space. In some cases, the transformer encoder block 406 encodes relationship data such as closeness in relevance scores, relatedness between nodes in a genealogy tree, and/or type of content item. As an example, the transformer encoder block 406 generates an attention based-embedding a₄ that represents: i) a particular type of content item (e.g., a story hint) following three content items a₁-a₃ of another type (e.g., record hints), ii) with a relevance score of 900 (lower than other content items in the sequence), iii) for an individual's grandmother (who is closely related to other nodes in the sequence).

As also illustrated in FIG. 4, the selection-prediction neural network includes an embedding block 408 for generating a tree-level embedding eₜᵣₑₑ from tree-level genealogical metrics (“tr”). To elaborate, the embedding block 408 generates, extracts, or encodes the tree-level embedding eₜᵣₑₑ which encodes data corresponding to tree-level genealogical metrics, such as: i) attached record count (e.g., a number of record content items associated with a user account or a node), ii) image count (e.g., a number of images associated with a user account or a node), and iii) story count (e.g., a number of story content items associated with a user account or a node). In some embodiments, the tree-level genealogical metrics further include: i) cumulative birth-marriage-death data (e.g., a number of birth-marriage-death records associated with a user account or a node), ii) cumulative census data (e.g., a number of census records associated with a user account or a node), iii) cumulative court record data (e.g., a number of court documents associated with a user account or a node), iv) cumulative directory data (e.g., a number of file storage directories associated with a user account or a node), v) cumulative military record data (e.g., a number of military records associated with a user account or a node), vi) cumulative immunization record data (e.g., a number of immunization records associated with a user account or a node), vii) cumulative maps data (e.g., a number of maps associated with a user account or a node), viii) cumulative reference data (e.g., a number of references made about a user account or a node in content items), and/or other data stored or encoded in a genealogy tree for a user account or a node.

As shown, the selection-prediction neural network also includes an embedding block 410 that generates a user account embedding eᵤₛₑᵣ from account-level genealogical metrics (“u”). In particular, the embedding block 410 extracts or encodes the user account embedding eᵤₛₑᵣ from account-level genealogical metrics, including: i) skill-score hint data (e.g., a skill score for a user account specific to using provided hints), ii) skill-score DNA data (e.g., a skill score for a user account specific to using and/or retrieving DNA data), iii) skill-score content data (e.g., a skill score for a user account specific to using and/or retrieving content items), iv) skill-score tree data (e.g., a skill score for a user account specific to using, creating, and/or modifying a genealogy tree), v) skill-score search data (e.g., a skill score for a user account specific to using search functions), vi) hintability group data (e.g., a hintability group for a user account), and/or other features stored for a user account.

As also shown, the genealogical-content prediction system 102 combines (e.g., concatenates) the attention-based embeddings a₁-a₅ with the tree-level embedding eₜᵣₑₑ and the user account embedding eᵤₛₑᵣ to generate a content embedding for a genealogical content item. More specifically, the genealogical-content prediction system 102 generates a content embedding specific to a content item, where the embedding includes features based on content-level genealogical metrics (and attention relationships derived from them), account-level genealogical metrics, and tree-level genealogical metrics.

As further illustrated in FIG. 4, the selection-prediction neural network includes fully connected layers 412. The fully connected layers 412 process the content item embedding for generating a selection prediction 414 (e.g., via a sigmoid function). For instance, the fully connected layers 412 generate the selection prediction 414 as a (normalized) probability that a user account (e.g., the user account associated with the account-level genealogical metrics processed by the embedding block 410) will select, view, or otherwise interact with a content item (e.g., the content item c₅), such as a person hint. In some embodiments, the selection-prediction neural network further includes a final activated layer (e.g., a logistic regression layer) for providing the selection prediction 414 and/or the content item embedding to downstream applications, systems, or models.

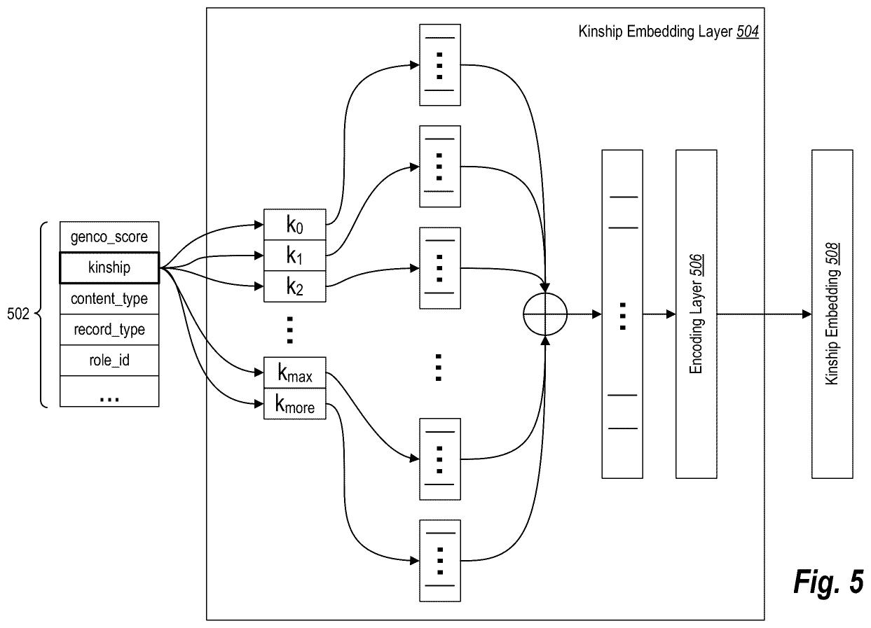

As mentioned above, in one or more embodiments, the genealogical-content prediction system 102 utilizes a selection-prediction neural network to identify recommended content items to surface to a user account (e.g., by comparing selection predictions). In particular, the genealogical-content prediction system 102 utilizes a selection-prediction neural network that includes various embedding blocks or embedding layers, including a kinship embedding layer (e.g., as part of the embedding block 404 described above). FIG. 5 illustrates an example architecture diagram for a kinship embedding layer 504 in accordance with one or more embodiments.

As illustrated in FIG. 5, the kinship embedding layer 504 is part of an embedding block (e.g., the embedding block 404) and extracts or encodes kinship embeddings from content items. Indeed, an embedding block, such as the embedding block 404, can include multiple embedding layers, each with their own neurons for processing respective content-level genealogical metrics. As shown, the kinship embedding layer 504 extracts features for encoding kinship data associated with a content item (or a node associated with a content item) in relation to a user account operating a client device.

As shown, the kinship embedding block processes a kinship data portion of a set of content-level genealogical metrics 502. Specifically, the kinship embedding layer 504 generates a set of kinship characters k₀-kₘₒᵣₑ, where each successive kinship character indicates a relationship to the immediately prior kinship character. In some cases, the character F represents a father relationship, the character M represents a mother relationship, the character Z represents a sister relationship, the character P represents a parent relationship, the character D represents a daughter relationship, the character S represents a son relationship, the character C represents a child relationship, the character E represents a spouse relationship, the character H represents a husband relationship, the character W represents a wife relationship, the character B represents a brother relationship, and the character G represents a sibling relationship. The kinship embedding layer 504 can thus concatenate characters together to form a kinship character string or a kinship encoding. For example, kinship characters of FFMZSW represent a father's father's mother's sister's son's wife.

In some embodiments, the kinship embedding layer 504 generates or extracts a kinship embedding 508 from a set of kinship characters. As shown, the kinship embedding layer 504 extracts kinship characters k₀-kₘₒᵣₑ and further generates character-level kinship embeddings from the kinship characters k₀-kₘₒᵣₑ. Additionally, the kinship embedding layer 504 combines (e.g., concatenates) the character-level kinship embeddings and utilizes an encoder layer 506 to generate the kinship embedding 508.

In some cases, the kinship embedding layer 504 applies a character threshold (e.g., 25 characters). Indeed, about 99% of kinships in the dataset of the genealogical data system 106 is captured with fewer than 25 kinship characters. However, the theoretical vocabulary size of 12²⁵ is enormous (the Oxford English dictionary contains approximately 300,000 entries, for reference). Such a large vocabulary is not manageable using most modern computer systems to train an embedder for kinship strings where the input dimension is the same as the vocabulary size. By using the character-level embedding described above and illustrated in FIG. 5, the genealogical-content prediction system 102 greatly reduces the input dimensionality to a constant (e.g., 329), resulting in huge computational savings in training and implementation. Indeed, reducing the input dimensionality from 12²⁵ to 329, the genealogical-content prediction system 102 reduces training and implementation expense, facilitating operation on devices that would otherwise be unable to process the data having a dimensionality of 12²⁵.

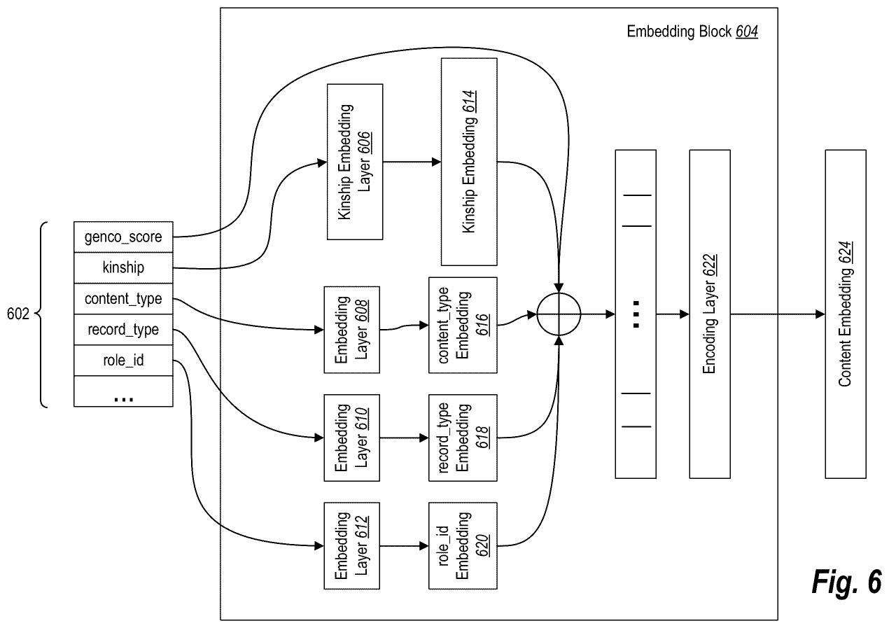

As indicated above, in certain embodiments, the genealogical-content prediction system 102 generates a content embedding based on content-level genealogical metrics, tree-level genealogical metrics, and account-level genealogical metrics. In particular, the genealogical-content prediction system 102 utilizes a selection-prediction neural network to generate a content embedding, where the selection-prediction neural network includes an embedding block for encoding content-level genealogical metrics (such as the embedding block 604). FIG. 6 illustrates an example architecture diagram for an embedding block in accordance with one or more embodiments.

As illustrated in FIG. 6, the embedding block 604 (e.g., the embedding block 404) generates or extracts a content embedding 624 from a set of content-level genealogical metrics 602. To this end, the embedding block 604 includes embedding layers for generating embeddings from respective metrics. For instance, the kinship embedding layer 606 (e.g., the kinship embedding layer 504 described above) extracts a kinship embedding 614 from a kinship metric. The embedding layer 608 extracts a content type embedding 616 from a content type metric. The embedding layer 610 extracts a database category embedding 618 (“record type”) from a database category metric. The embedding layer 612 extracts a role identifier embedding 620 from a role identifier metric.

As also illustrated in FIG. 6, the embedding block 604 includes an encoding layer 622 that generates the content embedding 624 from the extracted embeddings. Indeed, the embedding block 604 concatenates the kinship embedding 614, the content type embedding 616, the database category embedding 618 (e.g., the record type embedding), and the role identifier embedding 620 and further utilizes the encoding layer 622 to extract the content embedding 624 from the combination or concatenation.

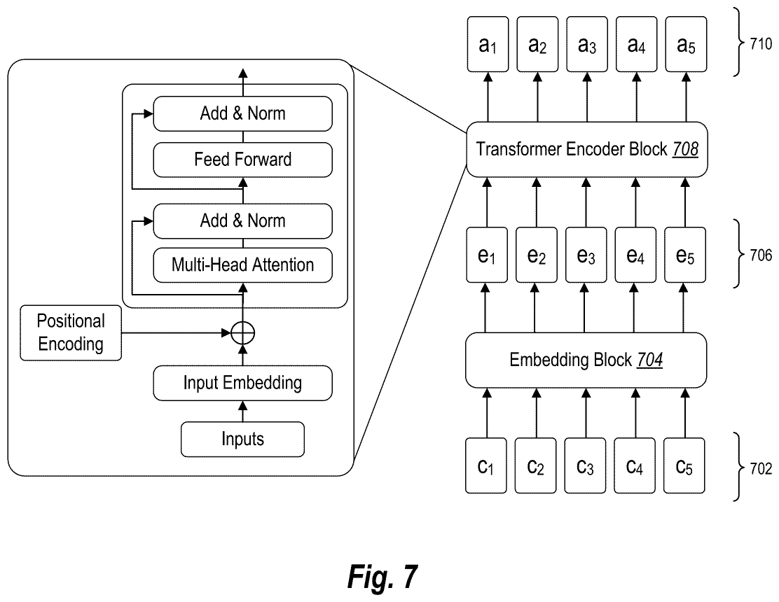

As mentioned above, the genealogical-content prediction system 102 utilizes a selection-prediction neural network that includes one or more transformer encoder blocks. In particular, a transformer encoder block extracts or generates attention-based content embeddings from content items (or from content embeddings extracted from content items using an embedding block). FIG. 7 illustrates an example architecture diagram for a transformer encoder block in accordance with one or more embodiments.

As illustrated in FIG. 7, the embedding block 704 (e.g., the embedding block 404) processes the content items 702 (or some other threshold number of content items) to generate corresponding content embeddings 706. Additionally, the transformer encoder block 708 processes the content embeddings 706 to generate attention-based content embeddings 710. To generate the attention-based content embeddings 710, the transformer encoder block 708 includes internal components, layers, or neurons, as shown in the expanded box in FIG. 7. The transformer architecture includes positional encoding layers, multi-head attention layers, addition and normalization layers, and feed forward layers.

Using the depicted architecture, the transformer encoder block 708 generates attention-based embeddings a₁-a₅. Specifically, the illustrated architecture uses an embedding block 704 to generate content embeddings 706 from content items 702 by extracting an embedding from each respective content item (e.g., where e₁ is extracted from c₁ and so forth). In addition, the illustrated architecture utilizes the transformer encoder block 708 (and its depicted internal layers) to generate or extract the attention-based embeddings content from the content embeddings 706 (e.g., where a₁ is encoded from e₁ and so forth).

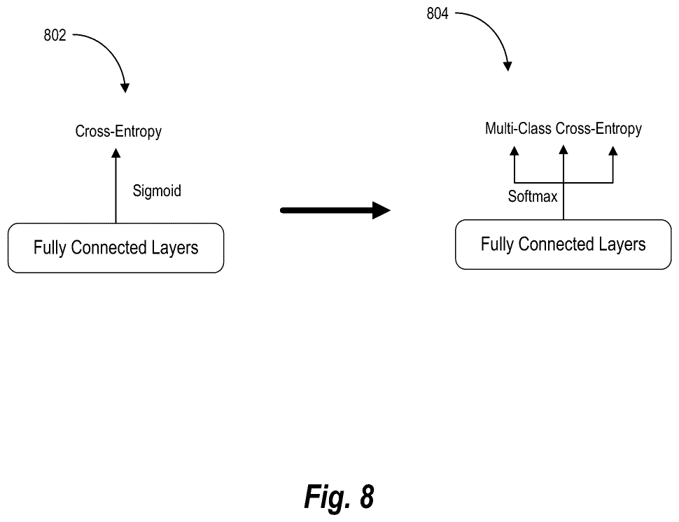

As noted above, in certain described embodiments, the genealogical-content prediction system 102 modifies parameters of a selection-prediction neural network to improve or enforce diversity among represented content items surfaced to a client device. In particular, the genealogical-content prediction system 102 can train a selection-prediction neural network to not only generate selection predictions but to do so according to multi-class parameter modification for content items across different classes or types. FIG. 8 illustrates an example modification for enforcing content diversity in a selection-prediction neural network in accordance with one or more embodiments.

As illustrated in FIG. 8, in some embodiments, the genealogical-content prediction system 102 can train the selection-prediction neural network using a cross-entropy loss function 802. More specifically, the genealogical-content prediction system 102 can utilize training data that includes sample genealogical content items and corresponding ground truth indications of selections, views, and/or other interactions.

As part of training, the genealogical-content prediction system 102 inputs a sample content item into the selection-prediction neural network, whereupon the selection-prediction neural network generates a selection prediction. The genealogical-content prediction system 102 further utilizes a loss function, such as the cross-entropy loss function 802, to compare the selection prediction with a ground truth indication of whether or not the content item was selected (e.g., where a prediction of 1 may represent a selection and a prediction of 0 may represent a non selection). In some cases, the genealogical-content prediction system 102 trains the selection-prediction neural network to generate selection predictions in the form of ratings (e.g., 1 through 5), where rating 1 represents a dismissal, rating 2 represents a review/selection and a rejection, rating 3 represents a review/selection and a pending interaction, rating 4 indicates either a save/share or a review/selection and a maybe interaction, and rating 5 indicates a review/selection and an accept interaction.

In addition, the genealogical-content prediction system 102 updates parameters (e.g., by performing back propagation) of the selection-prediction neural network (e.g., parameters of any of the layers, blocks, embedders, or encoders described herein) to reduce the measure of loss and improve accuracy for subsequent iterations. The genealogical-content prediction system 102 thus repeats the training process until the cross-entropy loss function 802 satisfies a threshold measure of loss (and/or for a threshold number of iterations or epochs). In some cases, the genealogical-content prediction system 102 uses another and/or an alternative loss function, such as a mean squared error loss function to compare predictions and ground truth data for training.

As also illustrated in FIG. 8, in one or more embodiments, the genealogical-content prediction system 102 can train the selection-prediction neural network using a multi-class cross-entropy loss function 804. More specifically, rather than using the cross-entropy loss function 602, in some case, the genealogical-content prediction system 102 uses the multi-class cross-entropy loss function 804 to modify network parameters for more even distribution across content item classes, categories, or types. In some cases, the multi-class cross-entropy loss function 804 involves determining losses across a multi-class classifier with three classes: i) irrelevant (not selected/reviewed), ii) relevant and not diverse (selected/reviewed and diversity criteria not met), and iii) relevant and diverse (selected/reviewed with diversity criteria met).

Accordingly, the genealogical-content prediction system 102 can enforce multi-class diversity for different content types. Indeed, the genealogical-content prediction system 102 can facilitate diverse content recommendations by adding additional tree-level genealogical metrics for cumulative citation/selection counts for a number of content types over a particular time period (e.g., the past 30 days). The categories or types for diversification can include: i) stories, memories, and histories, ii) birth-marriage-death records, iii) newspapers and periodicals, iv) directories and member lists, v) unspecified records, vi) court, land, wills and financial records, vii) military records, viii) dictionaries, encyclopedias, and reference records, ix) records with no category, x) census and voter list records, xi) immigration and emigration records, xii) maps, atlases, and gazetteer records, xiii) other records, xiv) pictures, and xv) genealogy trees.

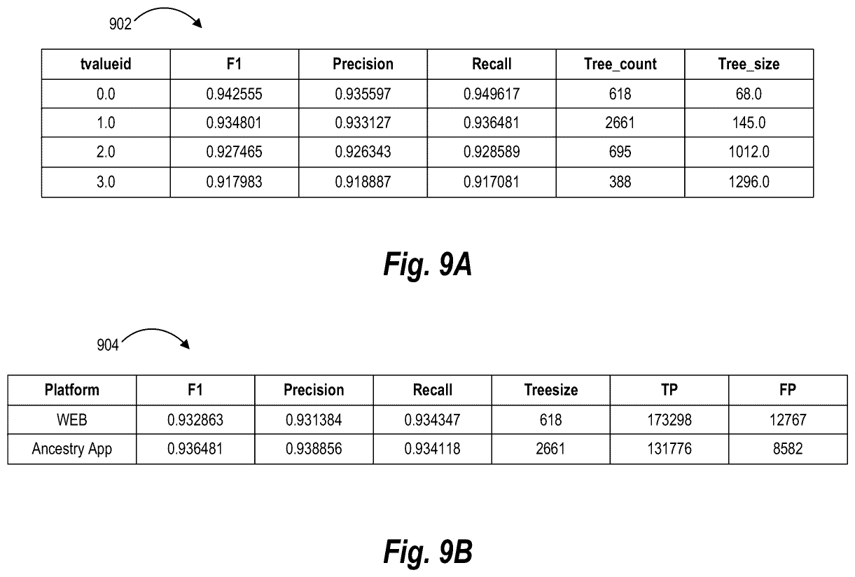

As indicated above, experimenters have demonstrated the performance of the genealogical-content prediction system 102. In particular, experimenters tested performance for embodiments of the genealogical-content prediction system 102 across different t-values and platforms. FIGS. 9A-9B illustrate example tables including experimental results for the genealogical-content prediction system 102 in accordance with one or more embodiments.

As illustrated in FIG. 9A, the table 902 indicates F1 scores (e.g., harmonic means of precision and recall) for embodiments of the genealogical-content prediction system 102. In the experiments, experimenters tested the genealogical-content prediction system 102 for different tree sizes and/or tree counts. The resulting F1 scores demonstrate accuracy improvements of the genealogical-content prediction system 102 over prior systems which achieve smaller F1 scores.

As illustrated in FIG. 9B, the table 904 includes experimental results for two different platforms: a web-based platform for surfacing recommended content items (corresponding to high selection predictions) via a webpage and a mobile platform for surfacing recommended content items in the mobile application. The table 904 includes F1 scores for different tree sizes, along with false positive (FP) and true positive (TP) counts. As shown, the F1 scores for both the web platform and the mobile platform are very good (above 0.93), improving over those of prior systems. The improvements are especially pronounced in the mobile platform where prior systems performed poorly by comparison.

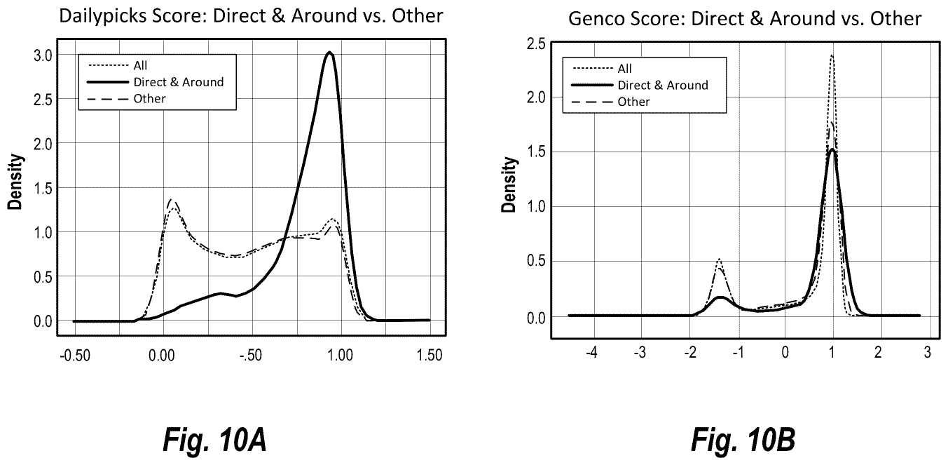

As mentioned, experimenters have demonstrated the improvements of the genealogical-content prediction system 102 over prior systems. In particular, the genealogical-content prediction system 102 improves over prior systems that rely solely on relevance scores for determining recommended content items. FIGS. 10A-10B illustrate example graphs depicting experimental results in accordance with one or more embodiments.

As illustrated in FIG. 10A, the table includes results for one or more embodiments of the genealogical-content prediction system 102. Particularly the table of FIG. 10A includes results for embodiments of the genealogical-content prediction system 102 that incorporate kinship data to generate or extract kinship embeddings as part of determining selection predictions for content items. As shown, the genealogical-content prediction system 102 prefers direct relatives and nodes around recently interacted content items and thus provides a greater distribution of scores (selection predictions) across content items.

As illustrated in FIG. 10B, by contrast, the table includes results for a prior relevance-based system. As shown, the prior model is not sensitive to kinship-related information, unlike the genealogical-content prediction system 102 of FIG. 10A. The prior model thus provides relatively little distribution across content items, spiking scores only where interactions occur. The prior model thus identifies less relevant content items to recommend, uninformed by kinship data defining relationships to the user account. Experimenters have thus demonstrated more accurate content recommendations for the genealogical-content prediction system 102 that incorporates kinship data, unlike prior systems that do not account for kinship data.

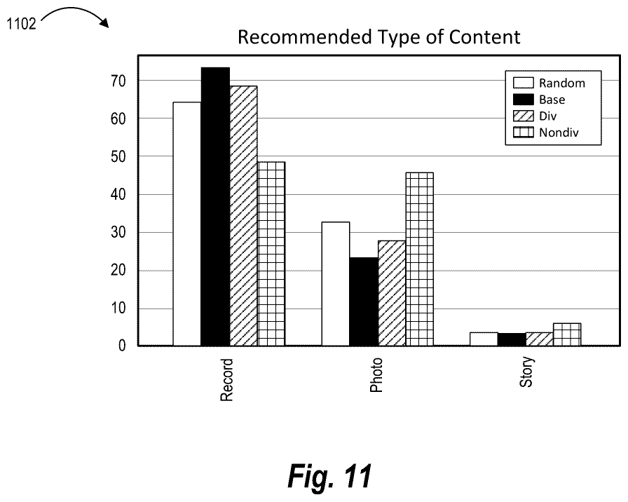

In addition to improving recommendations based on kinship data, in some embodiments, the genealogical-content prediction system 102 improves recommendation diversity in recommended genealogical content items. In particular, the genealogical-content prediction system 102 utilizes a selection-prediction neural network trained over multiple classes to improve diversity in recommended content types. FIG. 11 illustrates an example graph reflecting content diversity in recommended content in accordance with one or more embodiments.

As illustrated in FIG. 11, the graph 1102 includes a y-axis for percentage of the total recommended content items and an x-axis for content item types. The graph 1102 depicts results from an experiment over 777 unique genealogy tree IDs with 12,828 candidates over three types of content items: records, photos, and stories. As shown, the results for “random” indicate a random selection of recommended content items, “base” represents some embodiments of the genealogical-content prediction system 102 without enforcing diversity, “div” represents embodiments of the genealogical-content prediction system 102 enforcing diversity (e.g., when the number of citation categories <5), and “nondiv” represents embodiments of the genealogical-content prediction system 102 enforcing diversity (e.g., when the number of citation categories >=5). Indeed, experimenters have demonstrated that the genealogical-content prediction system 102 generates more diverse content recommendations, especially when the citation categories are more diverse. In some cases, a citation refers to a hint acceptance (e.g., an acceptance of a recommended content item) and/or a search success.

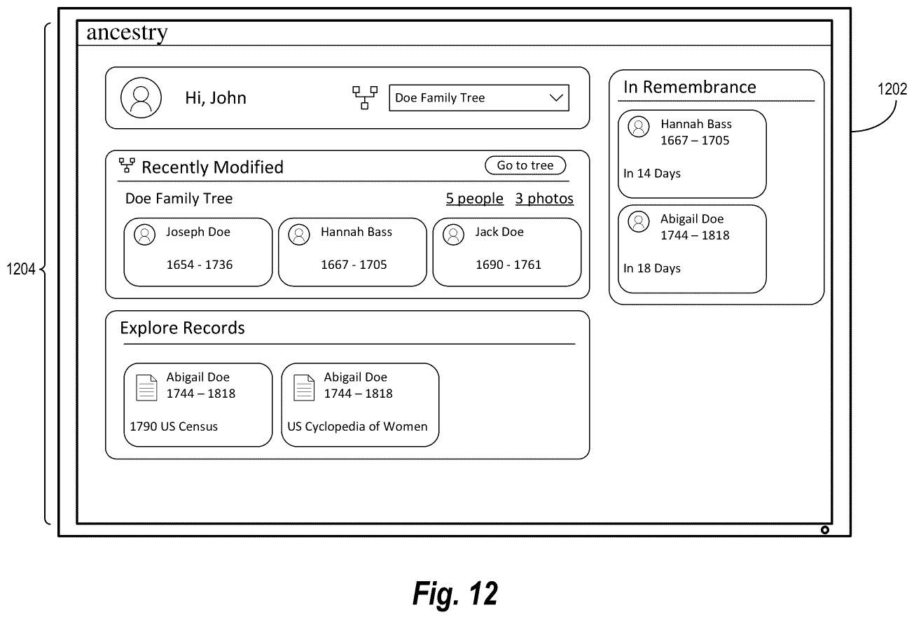

As mentioned above, in certain embodiments, the genealogical-content prediction system 102 generates and provides recommended content items for display on a client device. In particular, the genealogical-content prediction system 102 surfaces recommendations on web platforms and/or mobile platforms. FIG. 12 illustrates an example graphical user interface for surfacing recommended content items in accordance with one or more embodiments.

As illustrated in FIG. 12, the genealogical-content prediction system 102 generates and provides a recommendation interface 1204 for display on a client device 1202. Within the recommendation interface 1204 (e.g., a logged in homepage for the genealogical data system 106), the genealogical-content prediction system 102 provides various interface elements for viewing and selecting recommended genealogical content items. For example, the recommendation interface 1204 includes an element for “Recently Modified” content items corresponding to nodes that were recently modified in a genealogy tree (e.g., a tree associated with a user account logged in on the client device 1202).

Indeed, the genealogical-content prediction system 102 can provide a content recommendation based on one or more selection predictions for one or more genealogical content items. The genealogical-content prediction system 102 can provide the content recommendation for display within the “Recently Modified” element or within another interface element, depending on type of recommended item. For example, the recommendation interface 1204 includes an “Explore Records” element that depicts recommended records. In addition, the recommendation interface 1204 includes an “In Remembrance” element that depicts recommended content items for nodes for deceased individuals or tree persons.

In some embodiments, the recommendation interface 1204 includes additional or alternative interface elements, such as a “Review Stories” element that depicts recommended story items. The recommendation interface 1204 can also include a “Family Photos” element that depicts recommended photos of family members associated with the user account. Indeed, the genealogical-content prediction system 102 can generate and provide type-specific interface elements for display within the recommendation interface 1204 upon login by a user account, customizing the recommendations to the user account.

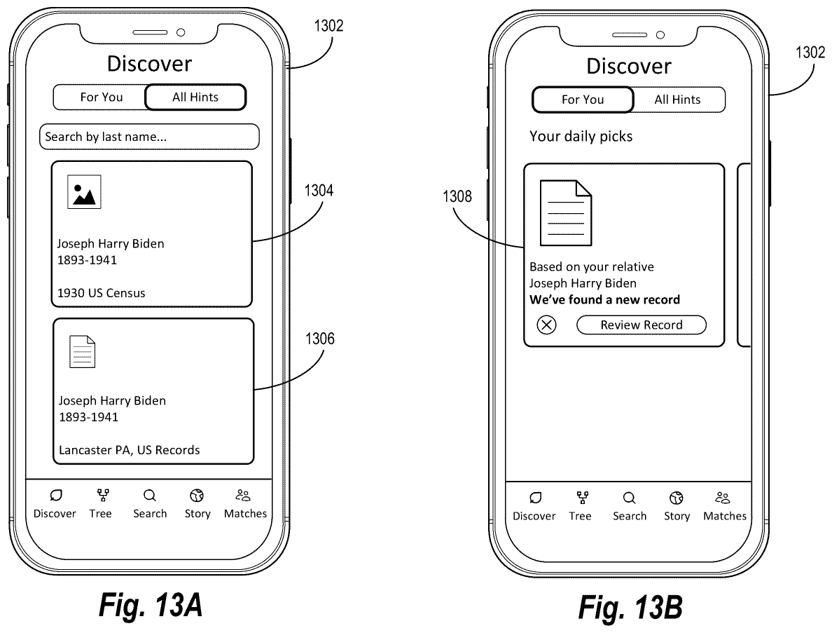

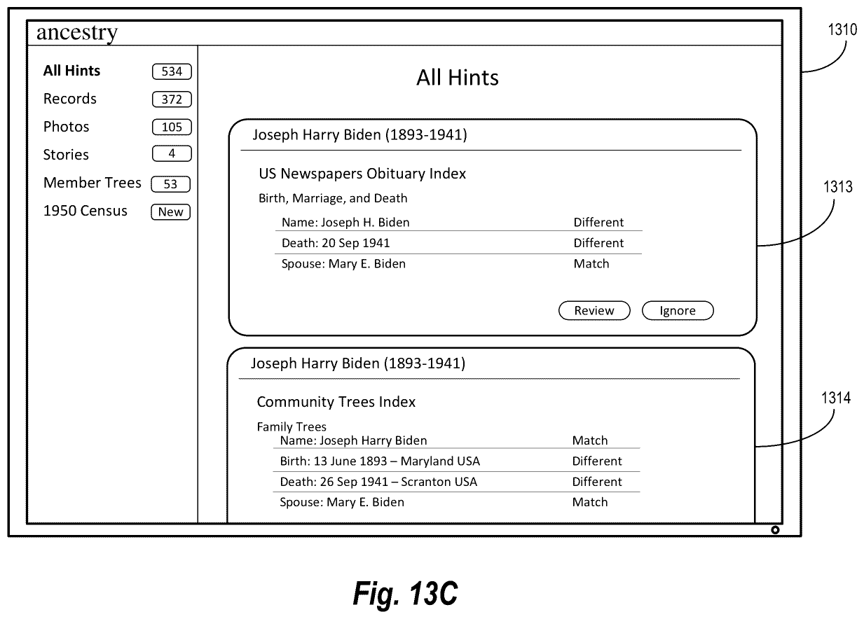

As mentioned, in certain embodiments, the genealogical-content prediction system 102 can generate and provide recommended content items for mobile and non-mobile (e.g., web-based) platforms. In particular, the genealogical-content prediction system 102 can provide cross-platform compatibility for recommended content items, tailoring the presentation according to the platform and the available screen space. FIGS. 13A-13C illustrate example graphical user interfaces for providing and displaying recommended content items based on selection predictions in accordance with one or more embodiments.

As illustrated in FIG. 13A, the genealogical-content prediction system 102 provides a recommended content item 1304 and a recommended content item 1306 for display on a client device 1302. Specifically, the mobile interface of FIG. 13A is an “All Hints” interface for presenting recommended content items irrespective of content type. The genealogical-content prediction system 102 thus determines selection predictions for the recommended content item 1304 and the recommended content item 1306. In some embodiments, the genealogical-content prediction system 102 determines the selection predictions based on a diversity metric to enforce diversity across multiple types of content items.

The genealogical-content prediction system 102 further compares the selection predictions to rank the content items. In some cases, the genealogical-content prediction system 102 presents a threshold number of top-ranked content items and/or content items whose selection predictions satisfy a threshold score or probability. As shown, the genealogical-content prediction system 102 selects the recommended content item 1304 as the highest-ranked and the recommended content item 1306 as the next highest-ranked, presenting them in ranked order in the mobile interface.

As illustrated in FIG. 13B, the genealogical-content prediction system 102 a recommended content item 1308 for display on the client device 1302 within a “For You” interface. In particular, the genealogical-content prediction system 102 provides the “For You” interface based on a selection of the toggle element to view recommended content items tailored for the user account according to preferences and/or content type. Indeed, the genealogical-content prediction system 102 determines selection predictions and provides daily picks of recommended content items, including the recommended content item 1308. In some embodiments, the genealogical-content prediction system 102 determines the selection predictions based on a diversity metric to enforce diversity across multiple types of content items. In some cases, the genealogical-content prediction system 102 ranks the recommended content items and presents the items in ranked order. As shown, the genealogical-content prediction system 102 provides the recommended content item 1308 based on a selection prediction for a content item corresponding to a relative of the user account.

As illustrated in FIG. 13C, the genealogical-content prediction system 102 provides illustrates a recommended content item 1313 and a recommended content item 1314 for display on a client device 1310. Indeed, the genealogical-content prediction system 102 generates and provides a web-based interface for non-mobile applications. As described above, the genealogical-content prediction system 102 determines and compares selection predictions for the recommended content item 1313 and the recommended content item 1314. The genealogical-content prediction system 102 further presents the content items in ranked order within the “All Hints” interface which includes recommendations across the various types of content items. As shown, the genealogical-content prediction system 102 can provide different content-type-specific recommendation interfaces based on selections in the left rail of “Records,” “Photos,” “Stories,” or other types of content items.

The components of the genealogical-content prediction system 102 can include software, hardware, or both. For example, the components of the genealogical-content prediction system 102 can include one or more instructions stored on a computer-readable storage medium and executable by processors of one or more computing devices. When executed by one or more processors, the computer-executable instructions of the genealogical-content prediction system 102 can cause a computing device to perform the methods described herein. Alternatively, the components of the genealogical-content prediction system 102 can comprise hardware, such as a special purpose processing device to perform a certain function or group of functions. Additionally or alternatively, the components of the genealogical-content prediction system 102 can include a combination of computer-executable instructions and hardware.

Furthermore, the components of the genealogical-content prediction system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the genealogical-content prediction system 102 may be implemented as part of a stand-alone application on a personal computing device or a mobile device.

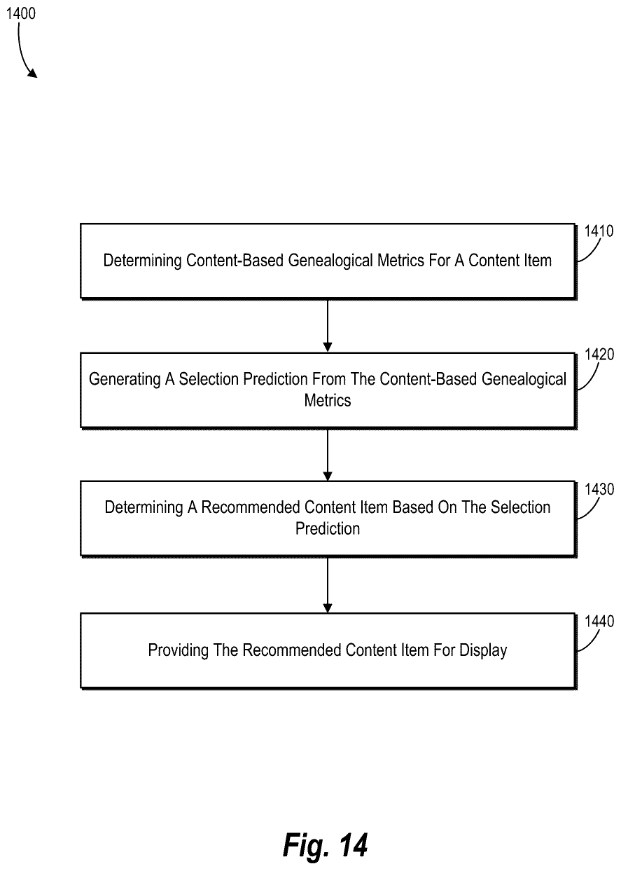

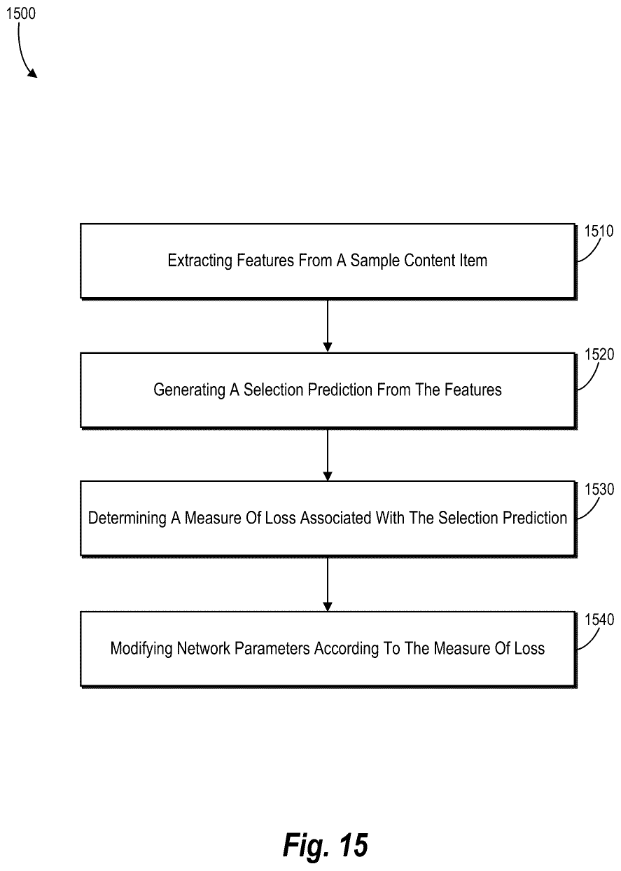

FIGS. 1-13C, the corresponding text, and the examples provide a number of different systems and methods for generating and providing content recommendations from selection predictions using a selection-prediction neural network. In addition to the foregoing, implementations can also be described in terms of flowcharts comprising acts steps in a method for accomplishing a particular result. For example, FIGS. 14-15 illustrate example series of acts for generating selection predictions and training a selection-prediction neural network.

While FIGS. 14-15 illustrate acts according to certain implementations, alternative implementations may omit, add to, reorder, and/or modify any of the acts shown in FIGS. 14-15. The acts of FIGS. 14-15 can be performed as part of a method. Alternatively, a non-transitory computer-readable medium can comprise instructions, that when executed by one or more processors, cause a computing device to perform the acts of FIGS. 14-15. In still further implementations, a system can perform the acts of FIGS. 14-15.

As illustrated in FIG. 14, the series of acts 1400 includes an act 1410 of determining content-based genealogical metrics for a content item. In particular, the act 1410 can involve determining content-level genealogical metrics for a content item from among a plurality of content items associated with a user account within a genealogical data system. In addition, the series of acts 1400 includes an act 1420 of generating a selection prediction from the content-based genealogical metrics. For example, the act 1420 involves generating, using a selection-prediction neural network, a selection prediction for the content item based on the content-level genealogical metrics. As shown, the series of acts 1400 includes an act 1430 of determining a recommended content item based on the selection prediction. In particular, the act 1430 involves, based on the selection prediction, determining a recommended content item to surface to a client device associated with the user account. Further, the series of acts 1440 includes an act 1440 of providing the content item for display. For instance, the act 1440 involves providing the recommended content item for display within a genealogical user interface on the client device.

In some embodiments, the series of acts 1400 includes an act of determining tree-level genealogical metrics for a genealogy tree database associated with the user account. The series of acts 1400 can also include an act of generating the selection prediction for the content item using the selection-prediction neural network further based on the tree-level genealogical metrics. Further, the series of acts 1400 can include an act of determining account-level genealogical metrics associated with the user account within the genealogical data system and an act of generating the selection prediction for the content item using the selection-prediction neural network further based on the account-level genealogical metrics.

The series of acts 1400 can include an act of determining previous client device interactions with genealogical content items associated with the user account. The series of acts 1400 can also include an act of generating the selection prediction for the content item using the selection-prediction neural network further based on the previous client device interactions. In addition, the series of acts 1400 can include an act of determining the content-level genealogical metrics for the content item by: identifying a node corresponding to the content item within a genealogy tree associated with the user account and generating a kinship embedding associated with the node within the genealogy tree.

In some cases, the series of acts 1400 includes an act of generating the kinship embedding by utilizing a kinship embedding block of the selection-prediction neural network to process kinship data from the content-level genealogical metrics. In these or other cases, the series of acts 1400 includes an act of comparing the selection prediction with a selection prediction threshold to determine that the selection prediction satisfies the selection prediction threshold.

In one or more embodiments, the series of acts 1400 includes an act of determining content-level genealogical metrics for a plurality of content items associated with a user account within a genealogical data system. In these or other embodiments, the series of acts 1400 includes an act of generating, using a selection-prediction neural network, selection predictions for the plurality of content items based on the content-level genealogical metrics. In addition, the series of acts 1400 can include an act of, based on the selection predictions, selecting a set of content items from among the plurality of content items according to a content-diversity metric. Further, the series of acts 1400 can include an act of providing the set of content items for display within a genealogical user interface on a client device.

In addition, the series of acts 1400 can include an act of providing the set of content items for display within the genealogical user interface by: providing a selectable option for a content item within the genealogical user interface and excluding an additional content item from the genealogical user interface based on an additional selection prediction for the additional content item. For example, the genealogical-content prediction system 102 provides a selectable option for a first item based on a selection prediction for the first item satisfying a threshold and excludes an option for a second content item based on a selection prediction for the second item failing to satisfy the threshold. Further, the series of acts 1400 can include an act of generating the selection predictions for the plurality of content items by: generating content embeddings from the content-level genealogical metrics utilizing the selection-prediction neural network and generating, from the content embeddings, probabilities of user interaction with the plurality of content items utilizing the selection-prediction neural network.

In some embodiments, the series of acts 1400 includes an act of generating a first selection prediction for a first content item and a second selection prediction for a second content item utilizing the selection-prediction neural network, wherein the first content item and the second content item are of different content types. In the same or other embodiments, the series of acts 1400 includes an act of providing the first content item and the second content item for display together within the genealogical user interface. The series of acts 1400 can also include an act of generating the selection predictions by using the selection-prediction neural network to process previous client device interactions with genealogical content items.

Additionally, the series of acts 1400 can include an act of utilizing the selection-prediction neural network to process previous client device interactions with genealogical content items by selecting, for a user account, up to a threshold number of previous client device interactions for processing by the selection-prediction neural network. Further, the series of acts 1400 can include acts of determining tree-level genealogical metrics for a genealogy tree database associated with the user account, determining account-level genealogical metrics associated with the user account, and generating the selection predictions for the plurality of content items by utilizing the selection-prediction neural network to process the content-level genealogical metrics, the tree-level genealogical metrics, and the account-level genealogical metrics. In some embodiments, the series of acts 1400 includes an act of ranking content items and providing content items for display based on the ranking. For instance, the series of acts 1400 includes an act of ranking content items according to selection predictions (as determined via the selection-prediction neural network) and providing one or more content items for display in ranked order (with those of highest selection predictions first).

As illustrated in FIG. 15, the series of acts 1500 includes an act 1510 of extracting features from a sample content item. In particular, the act 1510 can involve extracting one or more of content-level features, account-level features, or tree-level features for a sample content item stored in the genealogical database. The series of acts 1500 also includes an act 1520 of generating a selection prediction from the features. For example, the act 1520 can involve generating, utilizing the selection-prediction neural network, a selection prediction for the sample content item according to on the one or more of the content-level features, the account-level features, or the tree-level features. As shown, the series of acts 1500 includes an act 1530 of determining a measure of loss associated with the selection prediction. In addition, the series of acts 1500 can include an act 1540 of modifying network parameters according to the measure of loss. For example, the act 1540 can involve modifying parameters of the selection-prediction neural network according to the measure of loss.

In some embodiments, the series of acts 1500 includes an act of modifying the parameters of the selection-prediction neural network by updating the parameters based on a ground truth indication of client device interaction with the sample content item. In some cases, the selection-prediction neural network is (or includes) a regression model. In one or more embodiments, the series of acts 1500 includes an act of modifying the parameters of the selection-prediction neural network by modifying a multi-class classifier of the selection-prediction neural network according to a multi-class cross-entropy loss function to enforce diversity across content item types. In some embodiments, the selection-prediction neural network is a deep neural network based on a transformer encoder. The transformer encoder of the selection-prediction neural network can be (or include) a transformer encoder that processes content embeddings from previous client device interactions.

### Content-Item Feed Ranking Embodiments

In embodiments, a content-item feed-ranking system, method, and/or computer-program product are described. A feed-ranking approach can beneficially allow for sorting content for a user based on the user and not based on universal and inflexible heuristics. This allows a user's content feed to be as engaging as possible. What makes a content feed engaging will depend on the user. It has been found that this can be determined using a specialized machine-learning and architecture for receiving user data and adapting personal feeds according to the user data. Existing content feeds are not configured to surface social interactions and community-driven changes, which remain heavily buried and hidden from the user. This hampers a user's ability to collaborate with others, such as relatives, on family-history work, to appreciate the personal discoveries being made as a result of family-history work, and to engage meaningfully and long-term with the genealogical research service. This also limits the network effect of posts, content, and other activity on the genealogical research service, such that the majority of user outreach goes unanswered. Already completed family history work is, in this way, not successfully shared with others, such that work may be disadvantageously duplicated and valuable insights are not passed along to others.

Further, for new users of the genealogical research service, little content may be available for engaging with, thereby decreasing the likelihood of meaningful engagement, emotional connection, and retention. There is a need to appropriately link new users to a larger community, including people beyond the new users' close relatives, on the genealogical research service such that the new users may access meaningful content in the early moments of their use of the genealogical research service.

Additionally, a problem in existing feed ranking modalities is the response times for generating new content feeds, given the latency often incurred in processing data. This problem can be especially acute when receiving, processing, and displaying time-sensitive and-specific content, such as daily content items.

Another challenge with feed ranking is that it is cost prohibitive to store all items that could be displayed on a user's feed, necessitating improvements in how content data are processed, stored, and prioritized for users to minimize processing and storage requirements, delays, and costs for, e.g., a genealogical research service that provides a ranked content feed to a plurality of users.

In embodiments, the feed-ranking embodiments described herein allow a user to receive and engage with a personalized, ranked content feed based on, e.g., their interests, behavior patterns, and/or accessible content.

In embodiments, a feed-ranking system is configured to rank content items associated with a user for inclusion in a user's feed and to provide a ranked list of content for display on a user device. The feed-ranking system may comprise a feed cache manager configured as a stack responsible for keeping a user-specific cache of top, e.g. ranked, feed content items. The feed cache manager may be configured to listen for events published to an event bus (in embodiments, a system for publishing real-time events in response to user actions) to know when to add, remove, and/or change items in the cache. As events are consumed, the feed cache manager may be configured to initiate a per-user ranking process leveraging a ranking system to compute a new set of top feed items for storage. The new set of top feed items may replace or supersede a previously generated set of top feed items for the user.

The feed-ranking system may further comprise a feed session manager, comprising or cooperating with a stack configured to ensure that a user has a consistent view of feed items for a feed session, e.g. a discrete session in which a user is actively participating on or engaging with the genealogical research service. The ranking system may comprise or be configured to cooperate with a machine learning model or models configured to receive a set of content items and to generate a ranking thereof. The ranking system may be configured to iteratively request additional items to ensure that the output of the ranking system comprises optimized outputs for the user. In embodiments, the ranking system is configured to determine that additional items are needed. This may include specific requests for a specific number of items of a specific type, or may be a request for a predefined number of content items of any type, or any other request as suitable. The request may be generated before or after an initial ranking is performed by the ranking system. In embodiments, the ranking system is configured to receive a follow-up ranking based on the additional feed items, with the resulting ranking (comprising an index of ranking scores for the items and/or an ordered list of the feed items themselves) stored in a cache as suitable.

In some embodiments, the feed-ranking system may be configured to receive input including user data, such as user display names, like/comments counts for feed items (including user-specific likes, comments), user contacts including users who are family members or otherwise associated with the user, followers of the user, tree shares (e.g. contributors to a shared tree), or otherwise as suitable. The feed-ranking system may be configured to update the cache of top-ranked items stored in the feed cache manger in response to a user initiating a session, at a regular predefined cadence (such as daily), or otherwise as suitable, such as based on user behavior. In embodiments, in response to a user logging into their account, the feed-ranking system is configured to cause feed items to be added to and/or removed from the cache and the remaining cache to be re-ranked by the ranking system, resulting in a novel ranking.

The feed-ranking system may be configured to generate a predefined number of top content items. In embodiments, 200 top items, arranged as 10 pages of 20 items each, are generated from the content available to the feed-ranking system, but this is merely exemplary; other numbers of top items, arranged in any suitable fashion, may be generated as suitable. The predefined number and/or arrangement may differ based on the user behavior, content, or otherwise. Additionally, the feed-ranking system may dynamically adjust the top-ranked item during a user session based on user engagement or interaction with one or more feed items. For example, based on the user's engagement with a particular feed item (e.g. a photo associated with a particular ancestor), the feed-ranking system may update the top-ranked feed items to prioritize images and/or content regarding the particular ancestor.

In embodiments, the feed-ranking system ranks items based on user behavior and/or details, such as prioritizing items differently for frequent/regular users vs. new or infrequent users. In embodiments, the feed-ranking system is configured to receive a smaller set of contents for new or infrequent users and to output a smaller set of prioritized content items accordingly than for regular users. In embodiments, the feed-ranking system is configured to update the cache based on user events, e.g. user actions. Thus as a new user adds nodes to a genealogy tree, the feed-ranking system can utilize a cluster database to add content items from nodes associated with the new user-added nodes in the cluster database to the feed-ranking content cache. This allows the feed-ranking system to quickly spin up an engaging content feed for even new users during, e.g., an onboarding flow. During the onboarding flow, a user may be prompted to select one or more topics of interest, such as historical newspaper images, family collaborations, new image uploads, community-specific updates, holiday traditions, family recipes, siblings, fathers and daughters, fathers and sons, mothers and daughters, mothers and sons, first memories, funny moments, in memory of, favorite reads, family vacations, family celebrations, legendary tales, love stories, or any other suitable topic, with the user's selections being used in embodiments for customizing their feed via the feed-ranking system.

Other user events may include, in embodiments, a user accepting a photo/record/story hint; a user updating a fact in a node; or a user generating and/or editing content such as a post, a story, a collection, an uploaded image or record, or content otherwise being generated and indexed by the cluster database; another user adding feed items to a node of an associated tree or adding new nodes to the associated tree (e.g. a shared collaborative tree or a tree that includes shared nodes with a user's tree); user engagement with feed items, e.g. comments, likes, shares (whether on or off platform); changes in user preferences regarding content types, topics, or persons; views and durations of views; participation in membership in family or community groups; messages between users; DNA-related automatedly generated insights; DNA- and/or family-history-related survey questions posed by the genealogy research service; automatedly generated family-history trivia questions or other games; record, images, story, and/or tree-person automatedly generated hints; and other events as suitable.

Additionally, or alternatively, the feed-ranking system may update a user's feed-ranking cache in response to new content being added to the genealogy research service. For example, the genealogy research service may comprise and/or be configured to cooperate with a database of content items that is updated as users or the service upload new content, such as new images, records, stories, or other data. The newly uploaded content may be indexed and associated with users utilizing the aforementioned cluster database. For example, handwritten Census records may be uploaded to the database, handwriting recognition applied thereon, and names extracted from the handwritten Census records resolved to existing nodes or entities in the cluster database such that the newly acquired Census record can be linked to nodes of genealogy trees of individual users. As new content is associated with users, the user's ranked feed may be updated by the feed-ranking system. In embodiments, the user's ranked feed may be updated based on other users', for example associated users such as family, interactions with content. If, for example, a user's sibling views and/or saves an image, the saved image may be more-highly prioritized by the feed-ranking system.

In embodiments, a machine learning approach to feed ranking may entail training and utilizing for inference a model based on aggregated user and content data. For example, the feed-ranking machine learning model may comprise a segment and post-type model configured to predict engagement with a particular post for a given user segment, such as user segments defining a type of subscription level (free trial, registered user, subscription and/or pricing tiers, behavior classes such as “researcher,” “passenger”, etc.). The model may incorporate a number of likes and comments for, e.g., a given day, user segment, and/or post type, with continued training when used in production based on likes and comments by users/user segments in response to particular posts. The model may, in embodiments, be a logistic regression model configured to adjust weights in response to training data, which may comprise such features as user segment, post type (including, in embodiments, such prompts to and/or by a user as “accept a story hint,” “add a ugc story,” “add new person,” “accepted hint,” “edit person fact,” trivia, DNA survey, “accepted person,” “add community story,” “internal sharing,” “accept photo hint,” “add fact to person,” “accept record hint,” curated post, etc.), a number of likes, a number of comments, or any other suitable feature. The trained model in inference may be configured to assign a likelihood or relevance score to each content item of a plurality of content items.

In embodiments, post processing may include utilizing a bubble-sort algorithm on a first item of a plurality of content types, e.g. a community story, image upload, or genealogy tree update, to order the first items according to model score, and then repeat until all of the available-for-ranking content has been sorted. This advantageously enforces diversity of content type while also prioritizing according to relevance score from the model.

It has been found that users are more likely to have positive interactions with feed items ranked according to the above-mentioned model, with an increase in click rate of 34.7% and an increase in view duration of 16.1%.

In other embodiments, the model may be a gradient boosting model such as XGBoost, configured to receive a variety of features including user features, user/feed features, feed-item features, and/or any other suitable feature type. User features may include tree count (e.g. a number of trees associated with the user), total node count, max node count, average node count, referring to nodes in the trees associated with a user including the maximum and average numbers of nodes in trees, total attached record account (e.g. a total number of records attached to nodes in trees associated with the user), total image count (e.g. a total number of images attached to nodes in trees associated with the user), total story count (e.g. a total number of stories attached to nodes in trees associated with the user), total duration of user views of content items, duration of views of particular content item(s), or any other suitable feature. User/feed features may include entry feed (i.e. the first content feed displayed to a user) clicks, entry feed clicks over 7 days, entry feed clicks over 15 days, overall feed clocks (plus cumulatively over 7 and/or 15 days), overall post clicks (plus cumulatively over 7 and/or 15 days), total likes given (plus cumulatively over 7 and/or 15 days), total comments given (plus cumulatively over 7 and/or 15 days), total view time (plus cumulatively over 7 and/or 15 days), most recent content-item type, most common content-item type, post clicks by post type, or any other suitable feature. Feed-item types may include post type, like count(s), comment count(s), item views, item view time (plus cumulatively over 7 and/or 15 days), post age, report count, or any other suitable feature.

Training data may include a multiclass categorical variable (such as −1 for “negative clicks” such as report post, hide post, etc.; 0 for view without click; and 1 for “positive clicks” such as view post, like, visit poster's profile, etc.), a continuous variable, or a binary variable (negative click vs. no view or view with positive click) as suitable.

It has been found that gradient-boosting models such as XGBoost are prone to overfitting, have a high complexity of hyperparameters, and have a lack of interpretability. It was surprisingly found that using both L1 and L2 regularization parameters in the model, training and evaluating on one set and validating on another set of data not previously seen by the model, and keeping the n_iterations low advantageously contribute to avoiding overfitting in these data. Further, hyperparameters may be tuned using Bayesian optimization to optimize max_depth (e.g. maximum depth of a tree), alpha (L1 regularization term on weights), lambda (L2 regularization term on weights), eta (step size shrinkage), gamma (minimum loss reduction required to make a further partition on a leaf node of a tree), and/or min_child_weight (minimum sum of instance weight needed in a child; if the tree partition step results in a leaf node with the sum of instance weight less than the min_child_weight, then the building process will give up further partitioning) hyperparameters. This advantageously facilitates effective utilization of gradient boosting to learn from the above-mentioned features and to accurately generate relevance scores for content items for particular users, thereby facilitating an improved and personalized experience for users.

Post processing steps may advantageously include utilizing user behavior or other details to request additional content items for re-ranking the content items as suitable. For example, the model may be configured to receive a set of content items and to generate a ranking therefor. During post-processing, it may be determined by the feed-ranking system that the ranked set of content items has below a threshold number of content items of a particular type for a particular user. For instance, a user may be determined based on their behavior to prefer community stories, but in post-processing it is determined that the ranked set of content items only contains a single community story, versus three tree-person updates. The feed-ranking system may be configured to query a community-story module for additional community stories related to the user for inclusion in the set of content items and to utilize the model to rank the new set of content items.

In embodiments, social connections may be provided and ranked for a user, even in the absence of accompanying or associated content items. For example, a potential family-history match, such as a profile associated with a user who is determined to have similar interests and/or to share family ties or family-tree nodes with the user, may be provided as a content item.

Additional types of content items that may be received by the feed-ranking system, processed, ranking, post-processed, and/or displayed to a user may include, e.g., close DNA matches, ethnicity trivia questions based on a user's detected ethnicity, community, or other information, notable ancestors, and/or historical details, such as “100 Years Ago” posts. Notable ancestors may be determined by identifying using a family tree ancestors from a predefined number of generations and utilizing an algorithm to discover, score, and rank nodes based on quality and quantity of resources attached to their node.

In embodiments, a heuristic approach is utilized to provide varied posts that showcase the breadth of the genealogical research service's content and utility and to ensure user engagement. The heuristic approach may ensure that a user sees a variety of content upon login, that the most important and/or personalized content is shown first, and/or that the user sees new content on each visit, ensuring novelty and engagement. The content may be categorized by chronological metadata, such as publish date (and which may cover tree edit posts and/or internal share posts), personalized metadata, such as user preferences (and which may cover community stories and/or user-generated content posts), and/or service-sponsored content metadata, such as surveys, trivia questions, games, or other content configured to provide maximum educational, research, and/or entertainment value to a user. The heuristic approach may be configured to provide a predefined number of content items from one or more of the above-mentioned categories, such as 3-5 chronological items, 1-3 personalized items, and one service-sponsored item. Where ranges apply, the number actually selected may be randomized within the range for a user on a specific user session. Additionally, the above-mentioned categories may be prioritized, with chronological higher than personalized higher than service-sponsored.

The process may be repeated as needed to reach a predefined page size, such as 20 items per page with a predefined number of total pages. In the heuristic approach embodiments described, a user's expressed preferences may trump the predefined prioritization of categories, such that a user who has expressed interest in community stories may have unviewed community stories elevated to the top of their feed regardless of chronological date. Within stories, stories of the user's relatives may e prioritized over non-relatives, and then secondarily prioritized according to the user's other preferences. Stories may be selected based on a quality score, where a predefined number of points are assigned to stories based on, e.g., the author of the story being in a user's family circle, the story having audio, the story have a number of photo slides, the story having a number of text slides, and/or the story having a number of likes and/or comments from others.

In addition to the foregoing, implementations can also be described in terms of flowcharts comprising acts steps in a method for accomplishing a particular result. For example, FIGS. [ ] illustrate example series of acts for ranking a feed of content items.

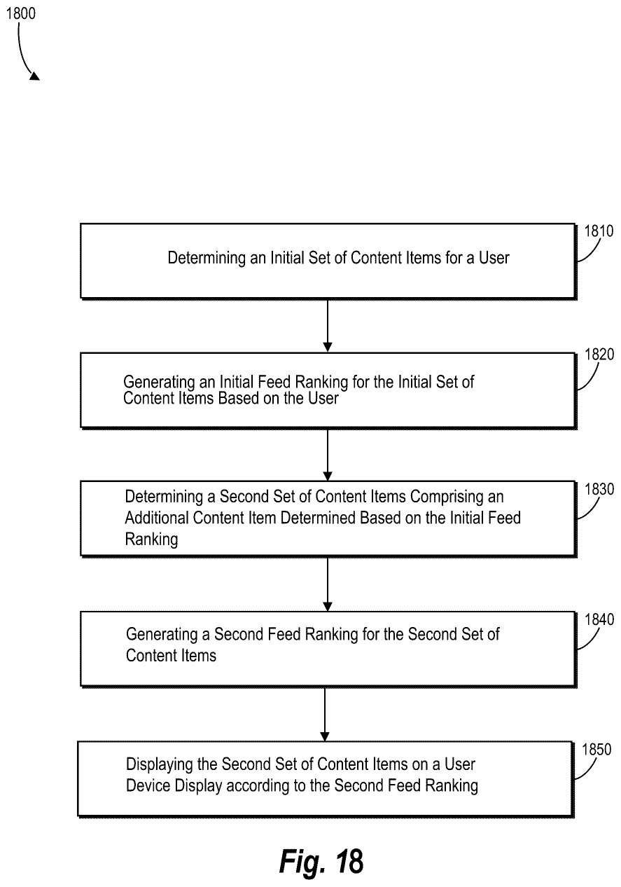

While FIG. 18 illustrates acts according to certain implementations, alternative implementations may omit, add to, reorder, and/or modify any of the acts shown in FIG. 18. The acts of FIG. 18 can be performed as part of a method. Alternatively, a non-transitory computer-readable medium can comprise instructions, that when executed by one or more processors, cause a computing device to perform the acts of FIG. 18. In still further implementations, a system can perform the acts of FIG. 18.

As illustrated in FIG. 18, the series of acts 1800 includes an act 1810 of determining an initial set of content items for user. This may comprise in embodiments compiling, retrieving, or otherwise generating a plurality of content items pertinent to a user. This may involve querying services for different product features, such as a genealogy trees service, a hints service, an image gallery service, a community stories service, or otherwise. In embodiments, the act 1810 may also include extracting one or more features from a set of content items, such as genealogy content items, for or associated with a user. The content items and/or features extracted therefrom may correspond to one or more categories of features, including user features, user/feed features, and content features. Features may include metadata such as number of likes, comments, and shares, associated trees, recent activity, or other metadata as suitable for one or more of the content items.

In embodiments, the initial set of content items includes at least one content item and/or feature extracted therefrom from each of user features, user/feed features, and content feature categories. Content items may be categorized using metadata as belonging to categories such as images, records, text, stories, facts, or otherwise. The categories may yet further include indications regarding whether content is user-generated or system-generated, directly from a user's genealogy tree or from a clustered node or a tree associated with a relative or other closely related user account.

In embodiments, features or other metadata are extracted from a profile associated with the user, such as name, associated genealogy trees, account history, user behaviors and/or skill profiles, or otherwise, in order to query appropriate services, databases, or otherwise for the content items of the initial set of content items. In embodiments, a predetermined number of content items for a user from one or more categories are compiled in the initial set of content items.

The series of acts 1800 further includes an act 1820 of generating an initial feed ranking for the initial set of content items, such as genealogy content items, based on the user and using a feed-ranking model. The feed-ranking model may be a trained model configured to infer a ranking score for a content item of the set of content items on the basis of, e.g., the initial set of content items and/or the one or more extracted features, and on the basis of the user. The feed-ranking model may be a gradient-boosting model such as XGBoost trained on a plurality of features, such as user features, user/feed features, feed-item features, and/or any other suitable feature type. The model may be configured to output a ranking or score for the content items in the set of content items.

The series of acts 1800 further includes an act 1830 of determining a second set of content items comprising an additional content item determined based on the initial feed ranking. In embodiments, it is determined that additional content items from a particular category of content items are needed given a number of content items from that category in initial feed ranking.

In embodiments, post-processing is performed on the initial feed ranking and/or the second feed ranking. Post-processing may include utilizing a bubble-sort algorithm or any other suitable modality for ensuring a desired user experience given the ranked content items, such that, for example, different types of content items are presented in a particular order (such as one content item per category at a time), with the highest-ranked content items from a category ranked higher than others.

In embodiments, the original set of content items is determined during post-processing by the feed-ranking model or based on the initial feed ranking to lack a desired or threshold number of content items from a particular category, based on, e.g., user preferences, user behaviors, or other learned parameters regarding the user. For example, the feed-ranking model may have learned weights regarding the features extracted from the user, and from this the feed-ranking model determines that the user, given their user segment, tree depth, behavior patterns, or otherwise, is more likely to respond to or engage with content of a particular type, such as image hints. In situations where the initial set of content items contains only a single image-hint content item, the feed-ranking model or associated components are configured to request additional image-hint content items up to, e.g., a threshold number. Additionally, or alternatively, in embodiments, the second set of content items comprises fewer content items of one or more categories determined based on the initial feed ranking to be superfluous or suboptimal for the user based on the extracted user features.

The series of acts 1800 includes an act 1840 of generating a second feed ranking for the second set of content items. The second set of content items may comprise at least one additional content item The at least one additional content item may correspond to the particular category of content items. The second feed ranking may be generating using the feed-ranking model used for generating the initial feed ranking or by a distinct model.

The series of acts 1800 may include an act 1850 of displaying the second set of content items on a user device display according to the second feed ranking. In embodiments, the second set of content items and the associated second feed ranking are stored, whether in the database, in the server(s), and/or on the user device, with the second feed ranking used to order the second set of content items on the user device display and optionally in storage.

By providing a feed-ranking system as described, the problem of content items being difficult to surface to users in ways that promote engagement by ensuring novelty, relevance, and personal meaning are addressed. The feed-ranking system is advantageously facilitated, in embodiments, by providing a machine-learned ranking modality empowered to request more content items of a type that is relevant to a user to improve the ranking and therefore the user's experience.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 16 illustrates a block diagram of exemplary computing device 1600 (e.g., the server(s) 104 and/or the client device 108) that may be configured to perform one or more of the processes described above. One will appreciate that server(s) 104 and/or the client device 108 may comprise one or more computing devices such as computing device 1600. As shown by FIG. 16, computing device 1600 can comprise processor 1602, memory 1604, storage device 1606, I/O interface 1608, and communication interface 1610, which may be communicatively coupled by way of communication infrastructure 1612. While an exemplary computing device 1600 is shown in FIG. 16, the components illustrated in FIG. 16 are not intended to be limiting. Additional or alternative components may be used in other implementations. Furthermore, in certain implementations, computing device 1600 can include fewer components than those shown in FIG. 16. Components of computing device 1600 shown in FIG. 16 will now be described in additional detail.

In particular implementations, processor 1602 includes hardware for executing instructions, such as those making up a computer program. As an example and not by way of limitation, to execute instructions, processor 1602 may retrieve (or fetch) the instructions from an internal register, an internal cache, memory 1604, or storage device 1606 and decode and execute them. In particular implementations, processor 1602 may include one or more internal caches for data, instructions, or addresses. As an example and not by way of limitation, processor 1602 may include one or more instruction caches, one or more data caches, and one or more translation lookaside buffers (TLBs). Instructions in the instruction caches may be copies of instructions in memory 1604 or storage device 1606.

Memory 1604 may be used for storing data, metadata, and programs for execution by the processor(s). Memory 1604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1604 may be internal or distributed memory.

Storage device 1606 includes storage for storing data or instructions. As an example and not by way of limitation, storage device 1606 can comprise a non-transitory storage medium described above. Storage device 1606 may include a hard disk drive (HDD), a floppy disk drive, flash memory, an optical disc, a magneto-optical disc, magnetic tape, or a Universal Serial Bus (USB) drive or a combination of two or more of these. Storage device 1606 may include removable or non-removable (or fixed) media, where appropriate. Storage device 1606 may be internal or external to computing device 1600. In particular implementations, storage device 1606 is non-volatile, solid-state memory. In other implementations, Storage device 1606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1608 allows a user to provide input to, receive output from, and otherwise transfer data to and receive data from computing device 1600. I/O interface 1608 may include a mouse, a keypad or a keyboard, a touch screen, a camera, an optical scanner, network interface, modem, other known I/O devices or a combination of such I/O interfaces. I/O interface 1608 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 1608 is configured to provide graphical data to a display for presentation to a user. The graphical data may be representative of one or more graphical user interfaces and/or any other graphical content as may serve a particular implementation.

Communication interface 1610 can include hardware, software, or both. In any event, communication interface 1610 can provide one or more interfaces for communication (such as, for example, packet-based communication) between computing device 1600 and one or more other computing devices or networks. As an example and not by way of limitation, communication interface 1610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1612 may include hardware, software, or both that couples components of computing device 1600 to each other. As an example and not by way of limitation, communication infrastructure 1612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 17 is a schematic diagram illustrating environment 1700 within which one or more implementations of the genealogical-content prediction system 102 can be implemented. For example, the genealogical-content prediction system 102 may be part of a genealogical data system 1702 (e.g., the genealogical data system 106). The genealogical data system 1702 may generate, store, manage, receive, and send digital content (such as genealogical content items). For example, genealogical data system 1702 may send and receive digital content to and from client devices 1706 by way of network 1704. In particular, genealogical data system 1702 can store and manage genealogical databases for various user accounts, historical records, and genealogy trees. In some embodiments, the genealogical data system 1702 can manage the distribution and sharing of digital content between computing devices associated with user accounts. For instance, the genealogical data system 1702 can facilitate a user account sharing a genealogical content item with another user account of genealogical data system 1702.

In particular, the genealogical data system 1702 can manage synchronizing digital content across multiple client devices 1706 associated with one or more user accounts. For example, a user may edit a digitized historical document or a node within a genealogy tree using client device 1706. The genealogical data system 1702 can cause client device 1706 to send the edited genealogical content to the genealogical data system 1702, whereupon the genealogical data system 1702 synchronizes the genealogical content on one or more additional computing devices.

As shown, the client device 1706 may be a desktop computer, a laptop computer, a tablet computer, an augmented reality device, a virtual reality device, a personal digital assistant (PDA), an in- or out-of-car navigation system, a handheld device, a smart phone or other cellular or mobile phone, or a mobile gaming device, other mobile device, or other suitable computing devices. The client device 1706 may execute one or more client applications, such as a web browser (e.g., Microsoft Windows Internet Explorer, Mozilla Firefox, Apple Safari, Google Chrome, Opera, etc.) or a native or special-purpose client application (e.g., Ancestry: Family History & DNA for iPhone or iPad, Ancestry: Family History & DNA for Android, etc.), to access and view content over the network 1704.

The network 1704 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1706 may access genealogical data system 1702.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
determining content-level genealogical metrics for a content item from among a plurality of content items associated with a user account within a genealogical data system;
generating, using a selection-prediction neural network, a selection prediction for the content item based on the content-level genealogical metrics;
based on the selection prediction, determining a recommended content item to surface to a client device associated with the user account; and
providing the recommended content item for display within a genealogical user interface on the client device.

2. The computer-implemented method of claim 1, further comprising:
determining tree-level genealogical metrics for a genealogy tree database associated with the user account; and
generating the selection prediction for the content item using the selection-prediction neural network further based on the tree-level genealogical metrics.

3. The computer-implemented method of claim 1, further comprising:
determining account-level genealogical metrics associated with the user account within the genealogical data system; and
generating the selection prediction for the content item using the selection-prediction neural network further based on the account-level genealogical metrics.

4. The computer-implemented method of claim 1, further comprising:
determining previous client device interactions with genealogical content items associated with the user account; and
generating the selection prediction for the content item using the selection-prediction neural network further based on the previous client device interactions.

5. The computer-implemented method of claim 1, wherein determining the content-level genealogical metrics for the content item comprises:
identifying a node corresponding to the content item within a genealogy tree associated with the user account; and
generating a kinship embedding associated with the node within the genealogy tree.

6. The computer-implemented method of claim 5, wherein generating the kinship embedding comprises utilizing a kinship embedding block of the selection-prediction neural network to process kinship data from the content-level genealogical metrics.

7. The computer-implemented method of claim 1, further comprising comparing the selection prediction with a selection prediction threshold to determine that the selection prediction satisfies the selection prediction threshold.

8. A non-transitory computer readable medium storing instructions which, when executed by at least one processor, cause the at least one processor to:
determine content-level genealogical metrics for a plurality of content items associated with a user account within a genealogical data system;
generate, using a selection-prediction neural network, selection predictions for the plurality of content items based on the content-level genealogical metrics;
based on the selection predictions, select a set of content items from among the plurality of content items according to a content-diversity metric; and
provide the set of content items for display within a genealogical user interface on a client device.

9. The non-transitory computer readable medium of claim 8, further storing instructions which, when executed by the at least one processor, cause the at least one processor to provide the set of content items for display within the genealogical user interface by:
providing a selectable option for a content item within the genealogical user interface; and
excluding an additional content item from the genealogical user interface based on an additional selection prediction for the additional content item.

10. The non-transitory computer readable medium of claim 8, further storing instructions which, when executed by the at least one processor, cause the at least one processor to generate the selection predictions for the plurality of content items by:
generating content embeddings from the content-level genealogical metrics utilizing the selection-prediction neural network; and
generating, from the content embeddings, probabilities of user interaction with the plurality of content items utilizing the selection-prediction neural network.

11. The non-transitory computer readable medium of claim 8, further storing instructions which, when executed by the at least one processor, cause the at least one processor to:
generate a first selection prediction for a first content item and a second selection prediction for a second content item utilizing the selection-prediction neural network, wherein the first content item and the second content item are of different content types; and
provide the first content item and the second content item for display together within the genealogical user interface.

12. The non-transitory computer readable medium of claim 8, further storing instructions which, when executed by the at least one processor, cause the at least one processor to generate the selection predictions by using the selection-prediction neural network to process previous client device interactions with genealogical content items.

13. The non-transitory computer readable medium of claim 12, further storing instructions which, when executed by the at least one processor, cause the at least one processor to utilize the selection-prediction neural network to process previous client device interactions with genealogical content items by selecting, for a user account, up to a threshold number of previous client device interactions for processing by the selection-prediction neural network.

14. The non-transitory computer readable medium of claim 8, further storing instructions which, when executed by the at least one processor, cause the at least one processor to:
determine tree-level genealogical metrics for a genealogy tree database associated with the user account;
determine account-level genealogical metrics associated with the user account; and
generate the selection predictions for the plurality of content items by utilizing the selection-prediction neural network to process the content-level genealogical metrics, the tree-level genealogical metrics, and the account-level genealogical metrics.

15. A computer-implemented method for ranking content items in a feed comprising:
determining an initial set of content items for a user, the content items comprising generating an initial feed ranking for the initial set of content items based on the user, wherein the initial feed ranking is generated by a feed-ranking machine learning model;
determining a second set of content items comprising an additional content item determined based on the initial feed ranking; and
generating a second feed ranking for the second set of content items.

16. The computer-implemented method of claim 15, wherein determining the second set of content items comprises:
processing the initial feed ranking to determine based on the user that a number of content items corresponding to a first category of the set of initial content items does not meet a threshold number of content items;
wherein the additional content item corresponds to the first category.

17. The computer-implemented method of claim 16, further comprising:
processing the initial feed ranking to determine based on the user that a number of content items corresponding to a second category of the set of initial content items exceeds a maximum threshold number of content items; and
removing a content item corresponding to the second category from the second set of content items.

18. The computer-implemented method of claim 15, wherein the feed-ranking machine learning model is a gradient-boosting model.

19. The computer-implemented method of claim 15, further comprising:
arranging the content items of the second set of content items according to a plurality of categories; and
applying the second feed ranking to the content items within the plurality of categories, wherein a top-ranked content item of a highest-priority category is ranked higher than a top-ranked content item of a second-highest-priority category.

20. The computer-implemented method of claim 19, further comprising:
causing a user device to display the second set of content items ordered according to the second feed ranking and the plurality of categories.
